(19) United States
(12) Patent Application Publication
(10) Pub. No.: US 2006/0037832 A1
(43) Pub. Date: Feb. 23, 2006

(54) Adaptable freewheel flow track systems, methods, and apparatus

(76) Inventors: Robert Joseph Lawless, Acworth, GA (US); Rumen V. Stoyanov, Acworth, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/208,066

(22) Filed: Aug. 19, 2005

Related U.S. Application Data
(60) Provisional application No. 60/603,101, filed on Aug. 19, 2004.

(51) Int. Cl. B65G 13/00

(52) U.S. Cl. 193/35 R

(57) ABSTRACT

The present invention comprises an adaptable transfer conveyor for the storage and movement of goods. One embodiment of the invention includes an adaptable transfer structure for conveying a load from a first location to a second location. The adaptable transfer structure can include at least one profile capable of supporting a wheel assembly, and a plurality of wheel assemblies capable of conveying a load. Each wheel assembly can include an axle with at least one end capable of mounting to the at least one profile, at least one wheel rotatably mounted to the axle, wherein the at least one wheel is capable of contacting a portion of the load. The wheel assembly can also include a spring capable of maintaining the position of the respective wheel assembly with the at least one profile, and further capable of permitting the manual removal of the respective wheel assembly from the at least one profile when the spring is compressed against either the at least one wheel or the at least one profile. Furthermore, the adaptable transfer structure can include an assembly support capable of mounting the at least one profile to a support structure

### RELATED APPLICATION

This application claims priority to U.S. Provisional Application Ser. No. 60/603,101, entitled “Adaptable Freewheel Flow Track Systems, Methods, and Apparatus,” filed on Aug. 19, 2004 the contents of which are hereby incorporated by reference.

### FIELD OF THE INVENTION

This invention relates to conveyor systems, and in particular, to adaptable transfer conveyor systems, methods, and apparatus for the storage and movement of goods.

### BACKGROUND OF THE INVENTION

A steel wheel track system, or skate wheel track system, is one conventional type of flow track system used in the material handling industry. The steel wheel track system can comprise a track assembly including one or more parallel track frames. Each track frame can include a pair of parallel steel frame members, also known as “profiles,” and multiple wheel assemblies mounted between the profiles. Each wheel assembly can include a steel wheel rotatably mounted on an axle that extends between the profiles transverse to the track flow direction. Ball bearings can be used in the wheels to increase the load capacity of the wheels and to enable the wheels to roll.

Another conventional type of flow track system utilizes relatively wide rollers instead of wheels. This type of “wide-roller” track system can comprise a track assembly including one or more parallel track frames. Each track frame can include a pair of parallel steel frame members, also known as “profiles,” and multiple roller assemblies mounted between the profiles. Each roller assembly can include a steel roller rotatably mounted on an axle that extends between the profiles transverse to the track flow direction.

The terms “transfer conveyor,” “transfer structure,” and “flow track system” are used interchangeably in this document, and are intended to generally describe conveyor systems for storing and transporting goods.

Drawbacks can exist with the types of systems described above. In some instances, the types of systems described above can be used to transport various shapes and sizes of cartons or boxes. However, space utilization can be a consideration for users especially when loads such as cartons and boxes are not uniform in shape or size. For example, wide-roller type systems may not be able to achieve relatively high space utilization if a particular carton width is greater than or less than the width of the underlying roller.

Furthermore, maintenance of these types of systems can be another consideration for users of these types of systems. When wheels and rollers are subjected to relatively high impact forces, these parts and associated components such as axles and supports may need to be replaced on a regular basis.

Moreover, conventional types of flow track systems are sometimes not adaptable to existing pallet frames or other types of frames for supporting pallets, slip sheets, or other loads. Pallet frames are conventional structures designed to support a series of pallet supported loads. In some instances, pallet frames or other types of frames must be retrofitted or otherwise modified with expensive and complex components in order to utilize conventional types of flow track systems.

As a result, it is desirable to provide adaptable transfer conveyor systems, methods, and apparatus for the storage and movement of goods.

It is also desirable to provide an adaptable wheel assembly for a transfer conveyor for the storage and movement of goods.

### SUMMARY OF THE INVENTION

The present invention relates to adaptable transfer structures enabling goods such as cartons to be transferred, for instance, from one location of a transfer conveyor to another location of the transfer conveyor by providing structures that permit various sizes and shapes of cartons to move between the portions of the transfer conveyor. The adaptable transfer structures can provide roller contact between at least a portion of the underside of the cartons some or all of time. Further, the present invention relates to a wheel apparatus or wheel assembly for an adaptable transfer conveyor that can be interchanged relatively quickly without special tools. Furthermore, the present invention relates to an support apparatus that can be adapted to a support structure such as a pallet frame, and can provide transfer conveyor features for the pallet frame. Methods of using the adaptable transfer structures, wheel apparatus or wheel assembly, and support apparatus are also described.

One embodiment of the invention includes an adaptable transfer structure for conveying a load from a first location to a second location. The adaptable transfer structure can include at least one profile capable of supporting a wheel assembly, and a plurality of wheel assemblies capable of conveying a load. Each wheel assembly can include an axle with at least one end capable of mounting to the at least one profile, at least one wheel rotatably mounted to the axle, wherein the at least one wheel is capable of contacting a portion of the load. The wheel assembly can also include a spring capable of maintaining the position of the respective wheel assembly with the at least one profile, and further capable of permitting the manual removal of the respective wheel assembly from the at least one profile when the spring is compressed against either the at least one wheel or the at least one profile. Furthermore, the adaptable transfer structure can include an assembly support capable of mounting the at least one profile to a support structure

Objects, features, and advantages of various embodiments of the invention include:
(1) Adaptable transfer structures and means for storing and transferring goods;
(2) Methods and apparatus for providing an interchangeable wheel assembly for transfer conveyor systems;
(3) Methods and apparatus for interchanging a wheel assembly for adaptable transfer conveyor systems; and
(4) Methods and apparatus for adapting a support structure to provide transfer conveyor system functionality.

Other objects, features and advantages of various embodiments according to the invention are apparent from the other parts of this document.

### BRIEF DESCRIPTION OF THE DRAWINGS

FIGS. 1-4 illustrate an adaptable transfer structure for an adaptable freewheel flow system in accordance with an embodiment of the invention.

FIGS. 5-11 illustrate a series of adaptable transfer structures for an adaptable freewheel flow system in accordance with an embodiment of the invention.

FIGS. 12-14 illustrate an example of a lane divider for an adaptable freewheel flow system in accordance with an embodiment of the invention.

FIGS. 15-18 illustrate various components of an adaptable freewheel flow system in accordance with an embodiment of the invention.

FIGS. 19A and 19B illustrate an example of a wheel assembly for an adaptable freewheel flow system in accordance with an embodiment of the invention.

FIGS. 20A and 20B illustrate another example of a wheel assembly for an adaptable freewheel flow system in accordance with an embodiment of the invention.

FIGS. 21 and 22 illustrate various components of an adaptable freewheel flow system in accordance with an embodiment of the invention.

FIGS. 23 and 24 illustrate methods of installation for various components of an adaptable freewheel flow system in accordance with an embodiment of the invention.

FIG. 25 illustrates three embodiments of an adaptable freewheel flow system in accordance with an embodiment of the invention.

FIGS. 26-33 illustrate example components of an adaptable freewheel flow system in accordance with an embodiment of the invention.

FIGS. 34-35 illustrate another adaptable transfer structure for an adaptable freewheel flow system in accordance with an embodiment of the invention.

FIGS. 36-37 illustrate components for components the adaptable freewheel flow system shown in FIGS. 34 and 35.

### DETAILED DESCRIPTION OF EMBODIMENTS OF THE INVENTION

The present invention relates to adaptable transfer structures enabling goods such as cartons to be transferred, for instance, from one portion of an adaptable transfer conveyor to another portion of the adaptable transfer conveyor by providing structures that permit various sizes and shapes of cartons to move between the portions of the adaptable transfer conveyor. The structures provide roller contact between at least a portion of the underside of the carton at all times. Further, the present invention relates to a wheel apparatus for an adaptable transfer conveyor that can be interchanged relatively quickly without special tools. Furthermore, the present invention relates to a support apparatus that can be adapted to a support structure such as a pallet frame, and can provide transfer conveyor features for the pallet frame. Methods of using the adaptable transfer structures, wheel apparatus, and support apparatus are also described.

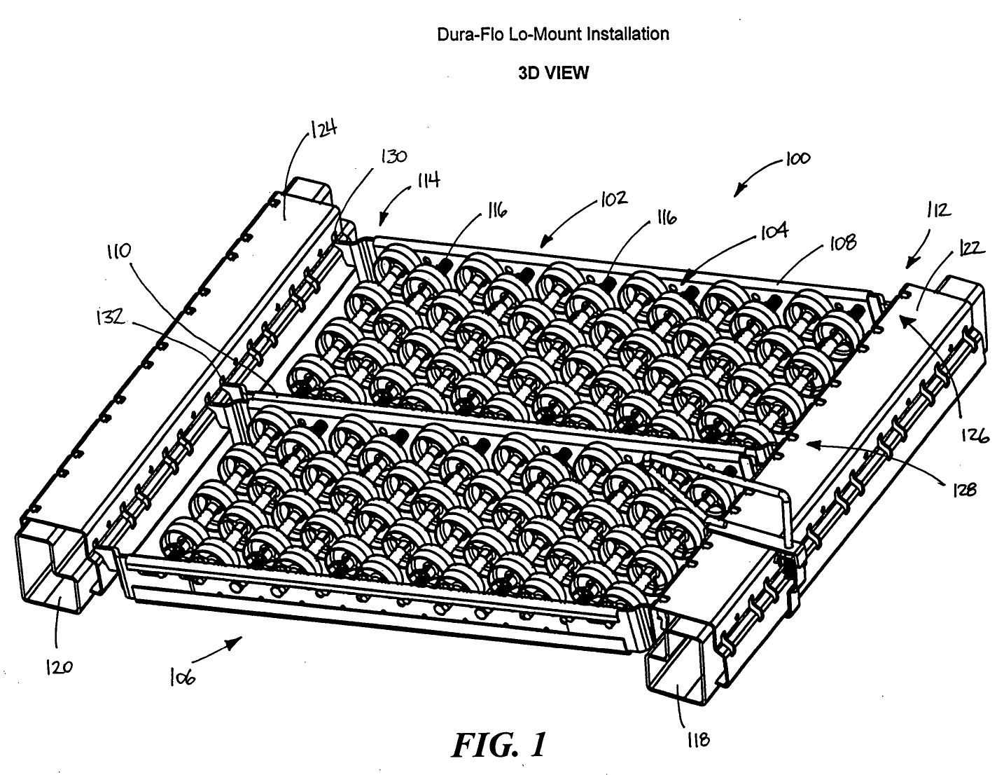

FIG. 1 illustrates a perspective view of a first embodiment of an adaptable transfer structure 100 for an adaptable freewheel flow system. In this example, the adaptable transfer structure 100 comprises a track assembly 102 and a series of wheel assemblies 104. The adaptable transfer structure 100 shown can be mounted in a side-by-side or adjacent orientation with at least one other transfer structure 106.

The track assembly 102 shown comprises a pair of longitudinally extending track frames or profiles 108, 110 extending from an input end 112 to an output end 114, and wheel assemblies 104 mounted to each track frame or profile 108, 110 for maintaining rolling engagement with a load such as a carton (not shown) on an upper surface of a portion of the wheel assemblies 104.

The wheel assemblies 104 can be arranged in a row or series extending from the input end 112 to the output end 114. Each of the wheel assemblies 104 includes an associated spring 116 or similar device enabling each wheel assembly 104 to be manually installed and removed from the track frames or profiles 108, 110 if repair or replacement is needed. Loads such as cartons (not shown) can be supported by the track assembly 102 and associated wheel assemblies 104, and can be further transported in a track flow direction extending from the input end 112 to the output end 114.

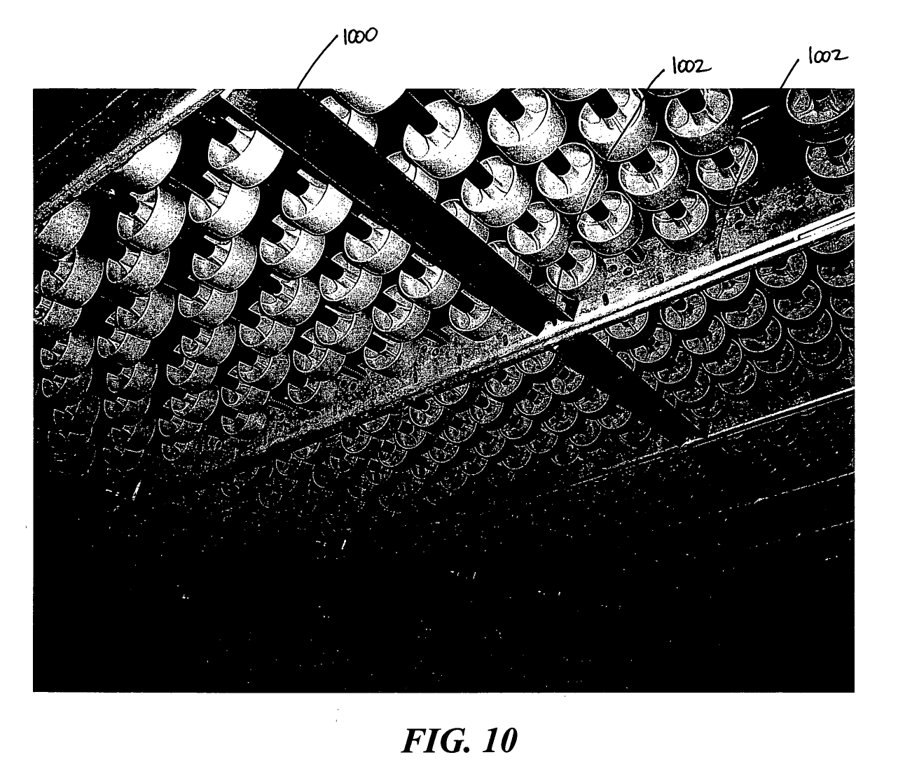

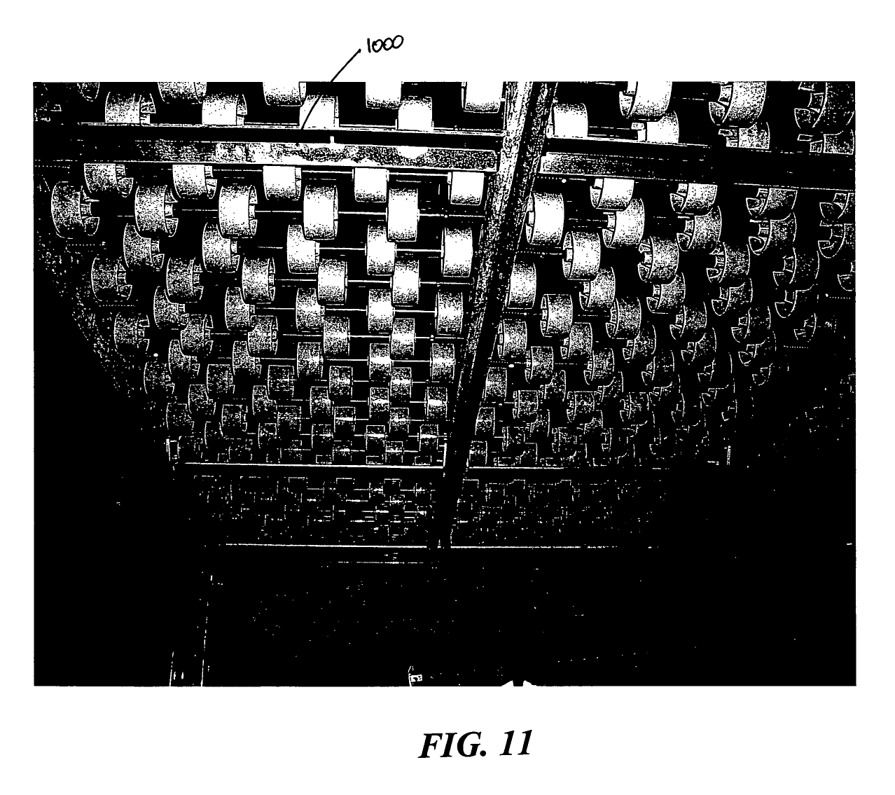

Each of the profiles 108, 110 can be supported by a support structure, such as beams 118, 120 associated with a pallet frame, or by track assembly supports 122, 124. One or more relatively long spacer bars, shown as 1000 in FIGS. 10 and 11, or threaded fastening rods can fasten the profiles 108, 110 together in a spaced apart relationship, forming a relatively wide channel between the profiles 108, 110. That is, the width of the channel can be relatively greater than the width of an associated load such as a carton. In other embodiments, the width of the channel can be relatively smaller than the width of a carton or other load.

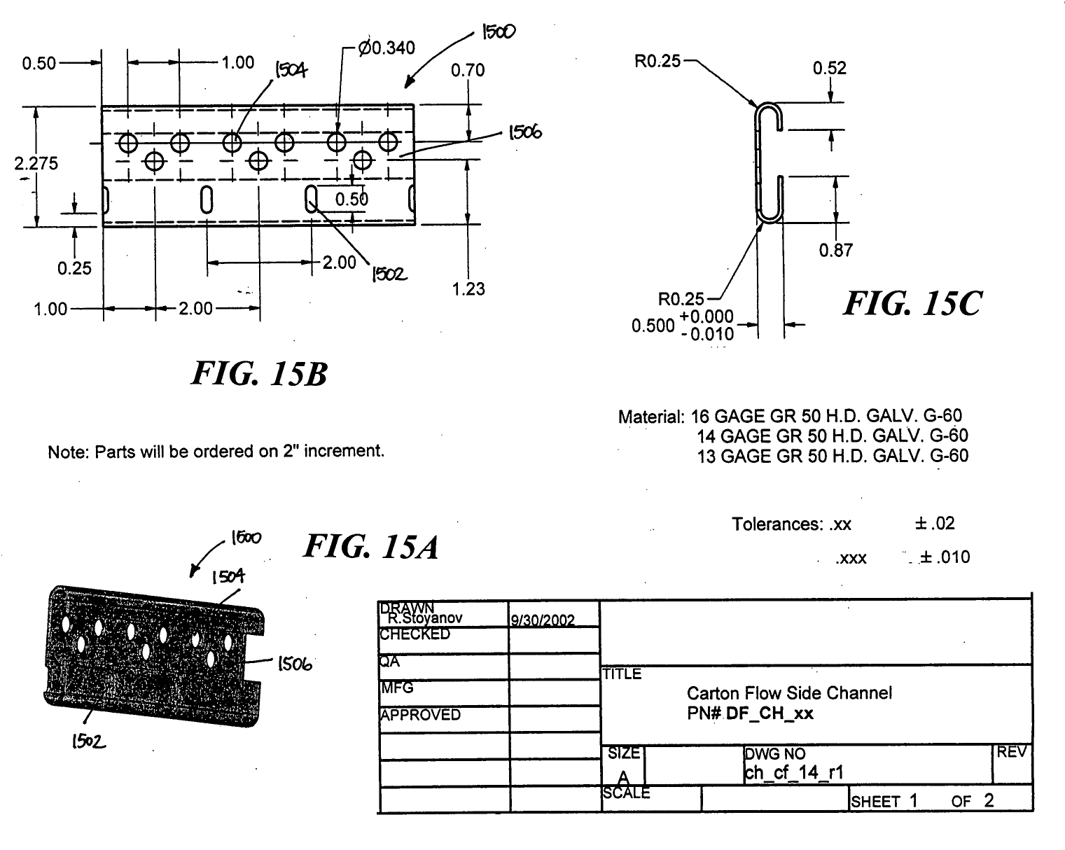

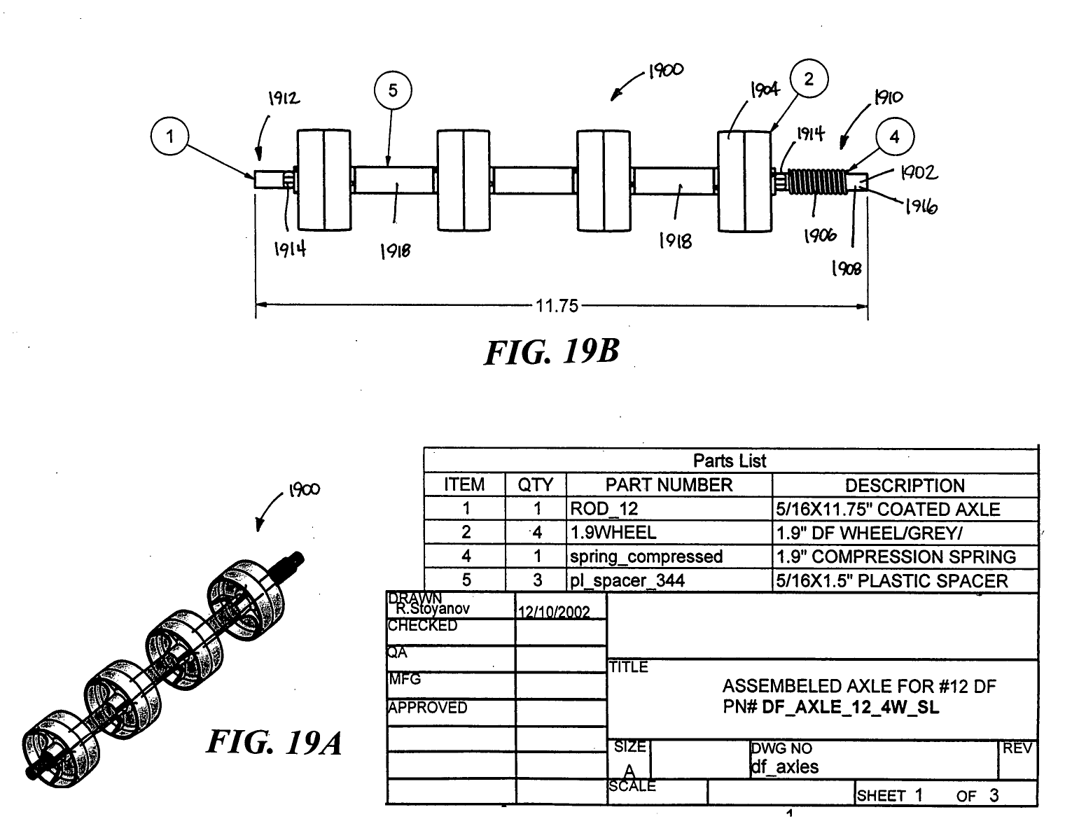

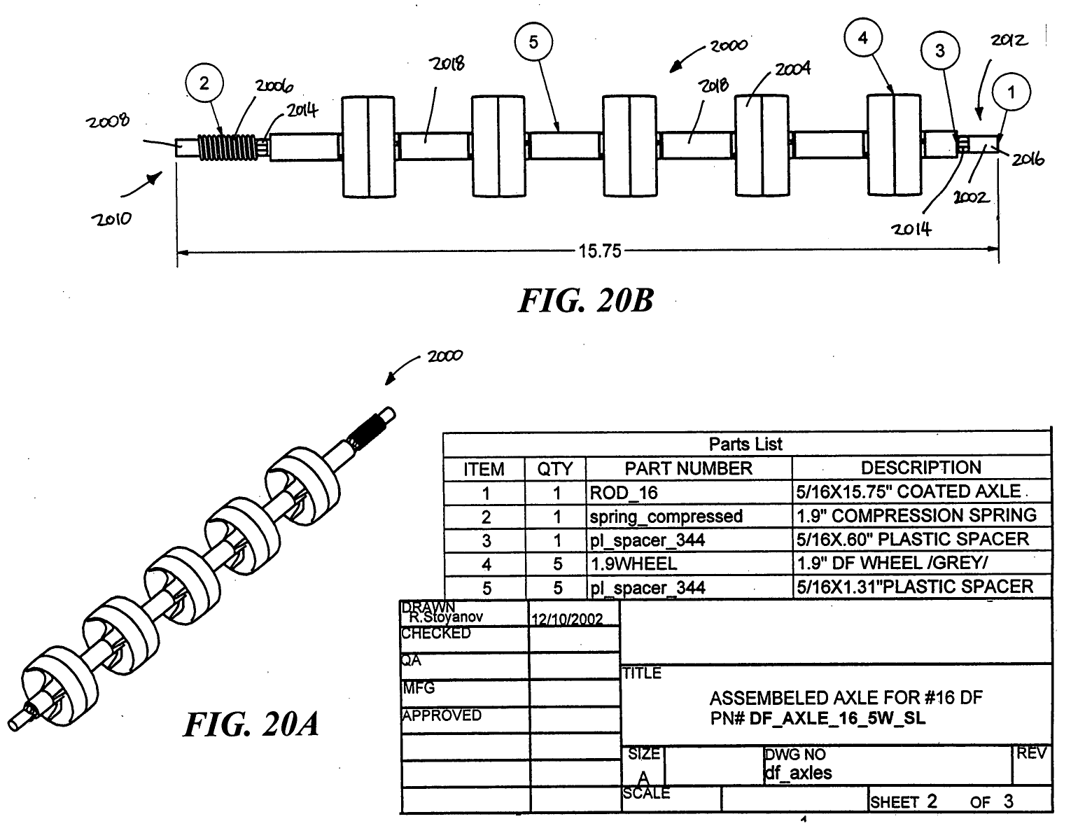

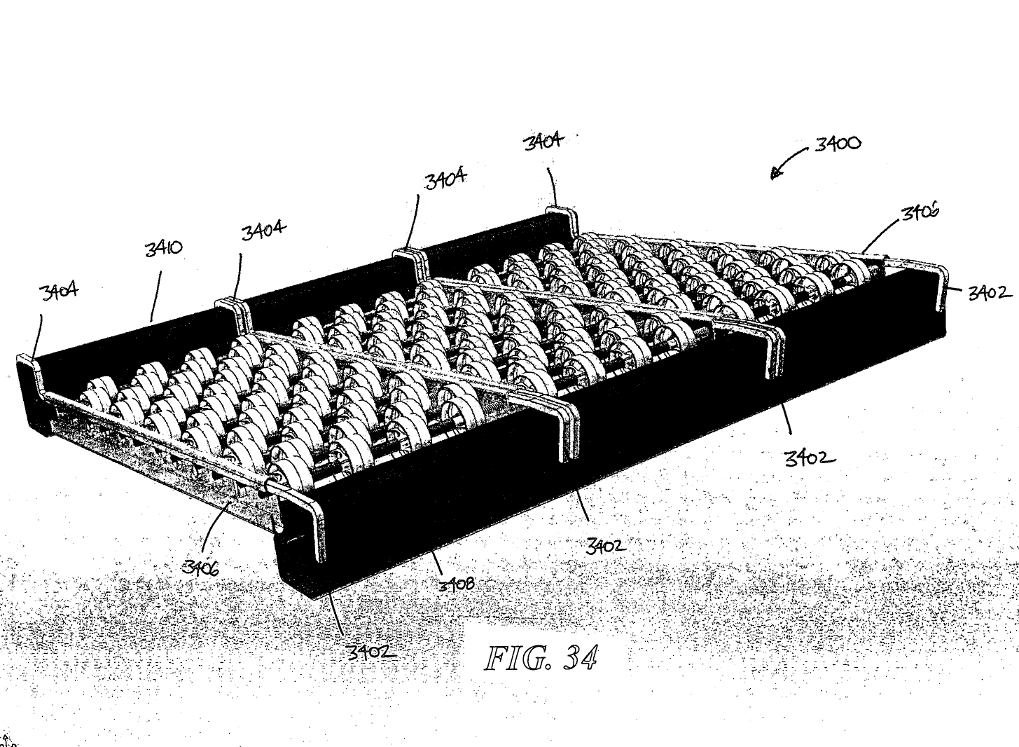

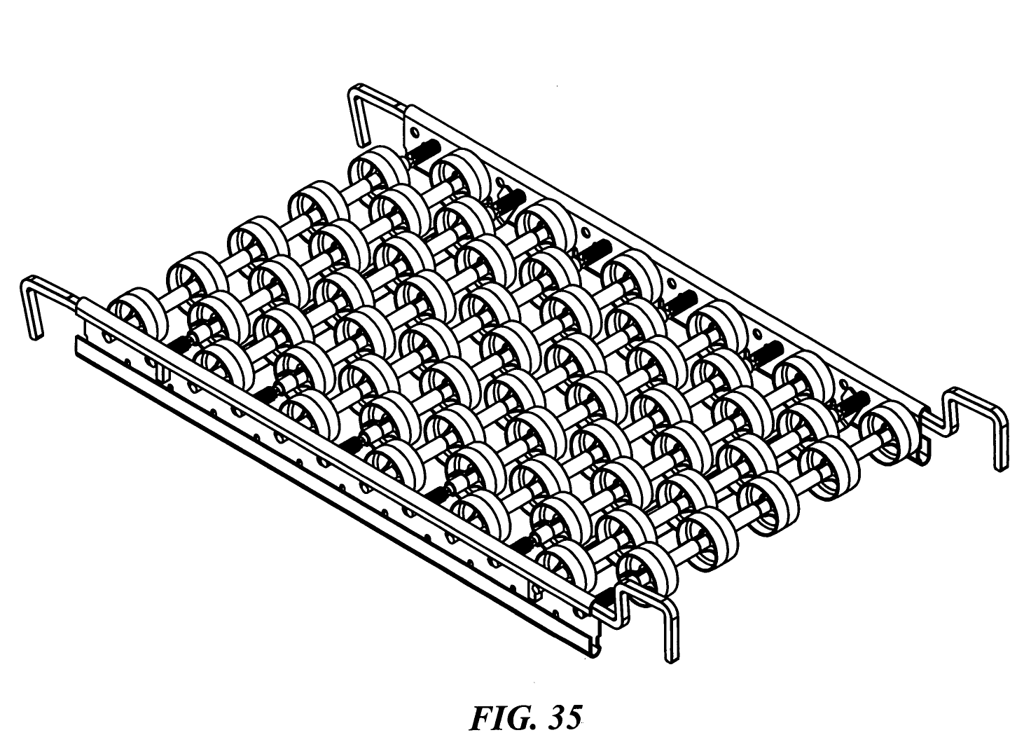

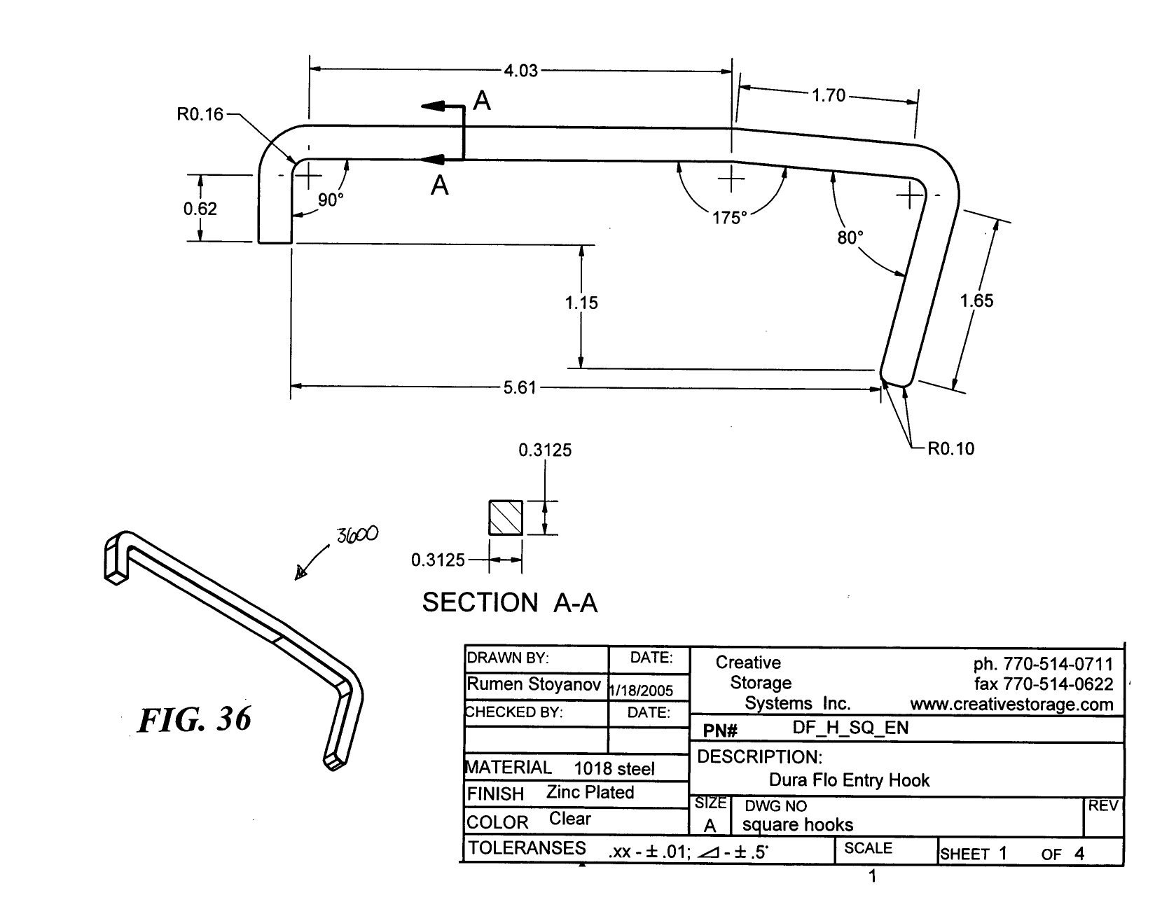

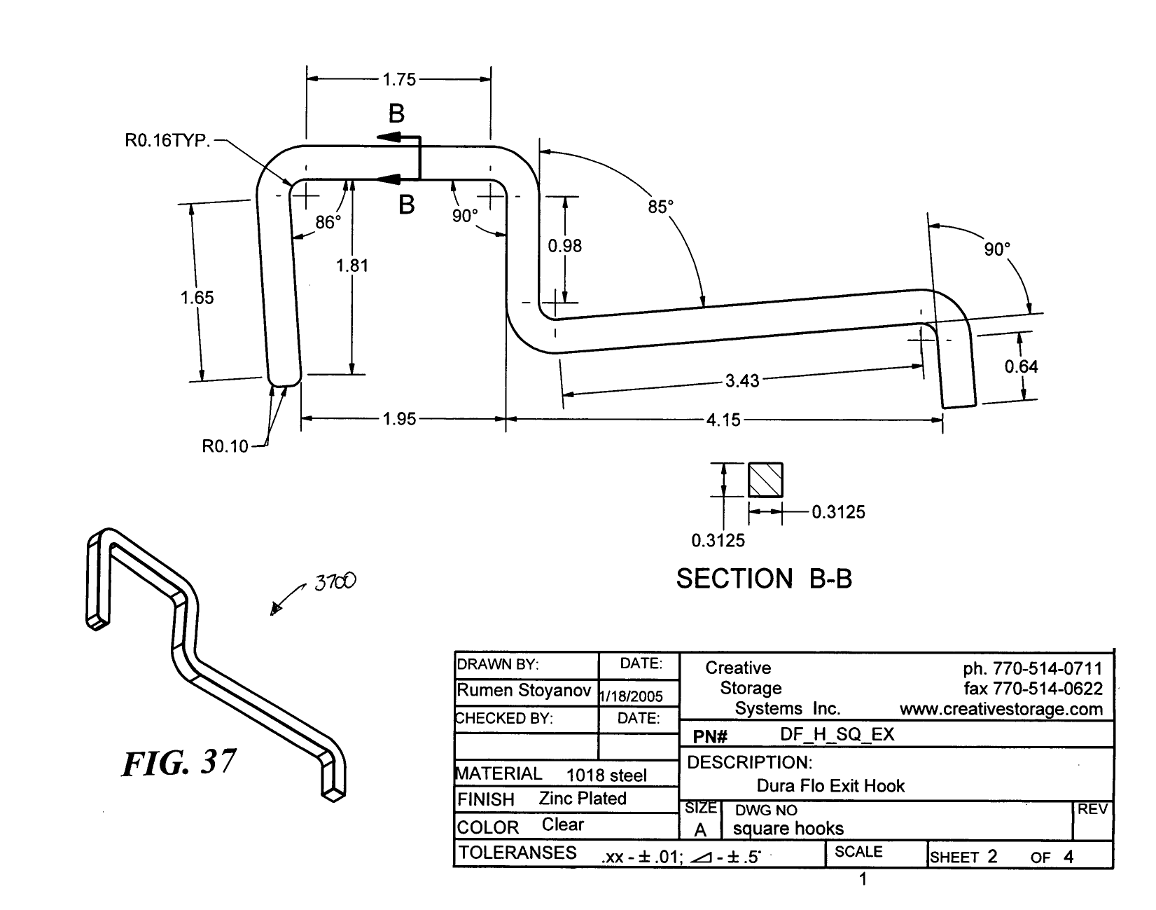

Examples of components for a track assembly are shown in FIGS. 15A-15C, 16A-16F, and 17A-17F and described in greater detail below. Examples of components for wheel assemblies 104 are shown in FIGS. 19A, 19B, 20A and 20B and described in greater detail below. Other configurations of components for a track assembly and wheel assembly can exist in accordance with other embodiments of the invention. For example, another embodiment of an adaptable transfer structure is shown and described in FIGS. 34 and 35. Components for the adaptable transfer structure shown in FIGS. 34 and 35 are shown in FIGS. 36 and 37 described below.

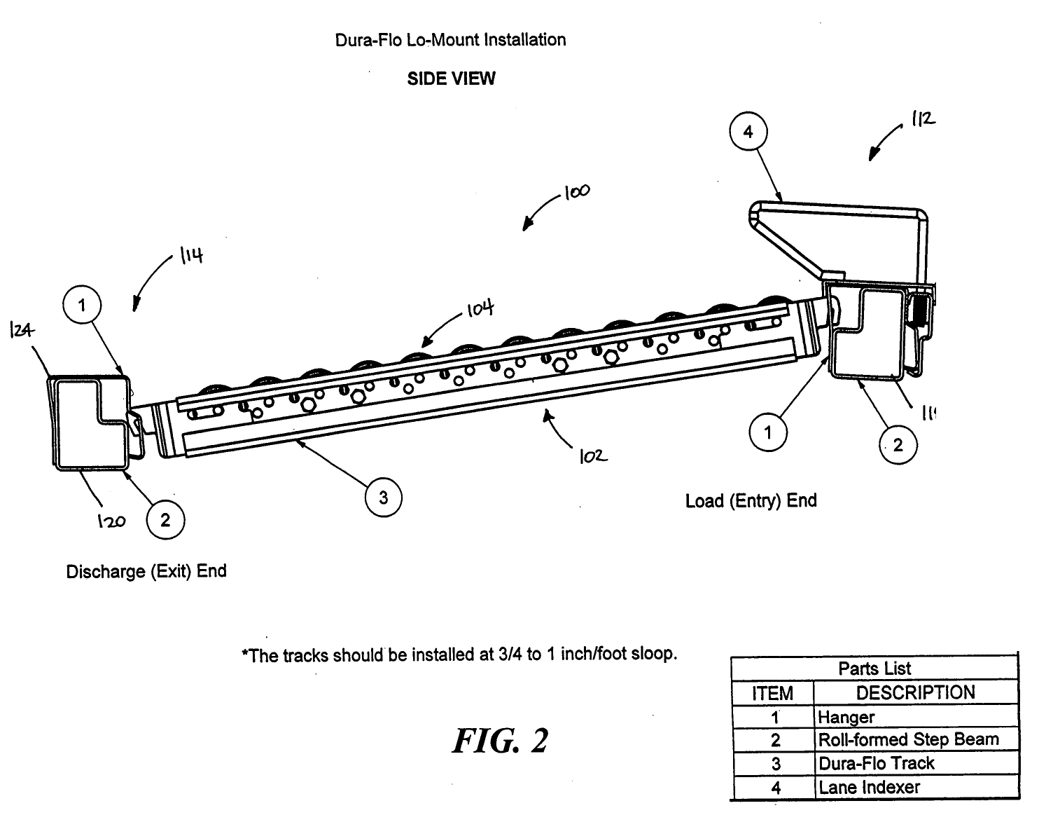

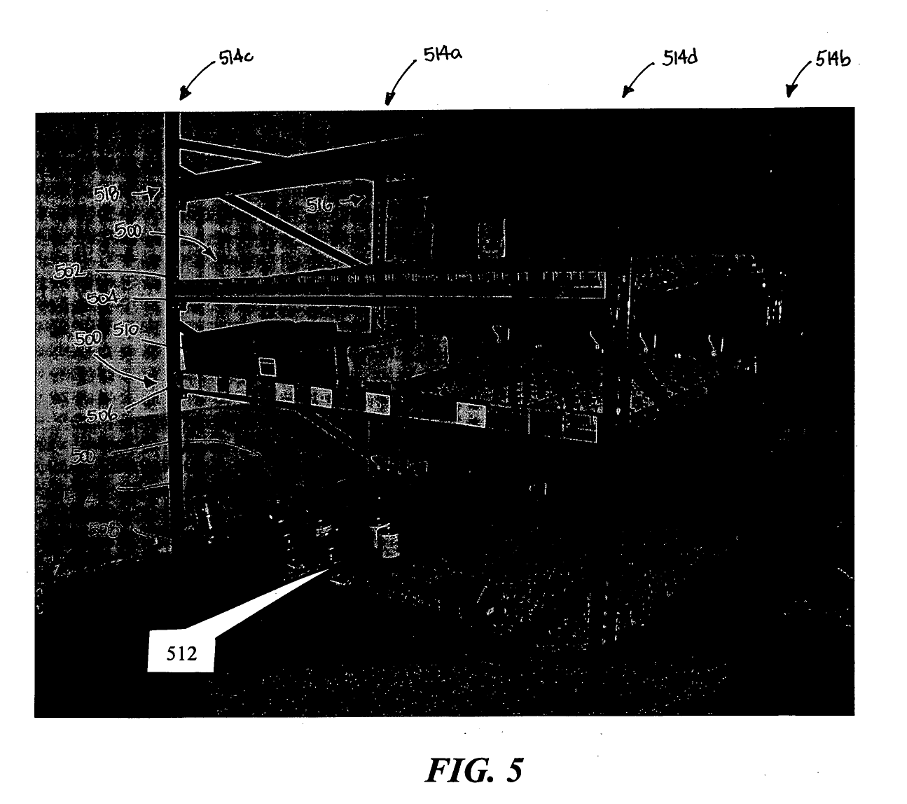

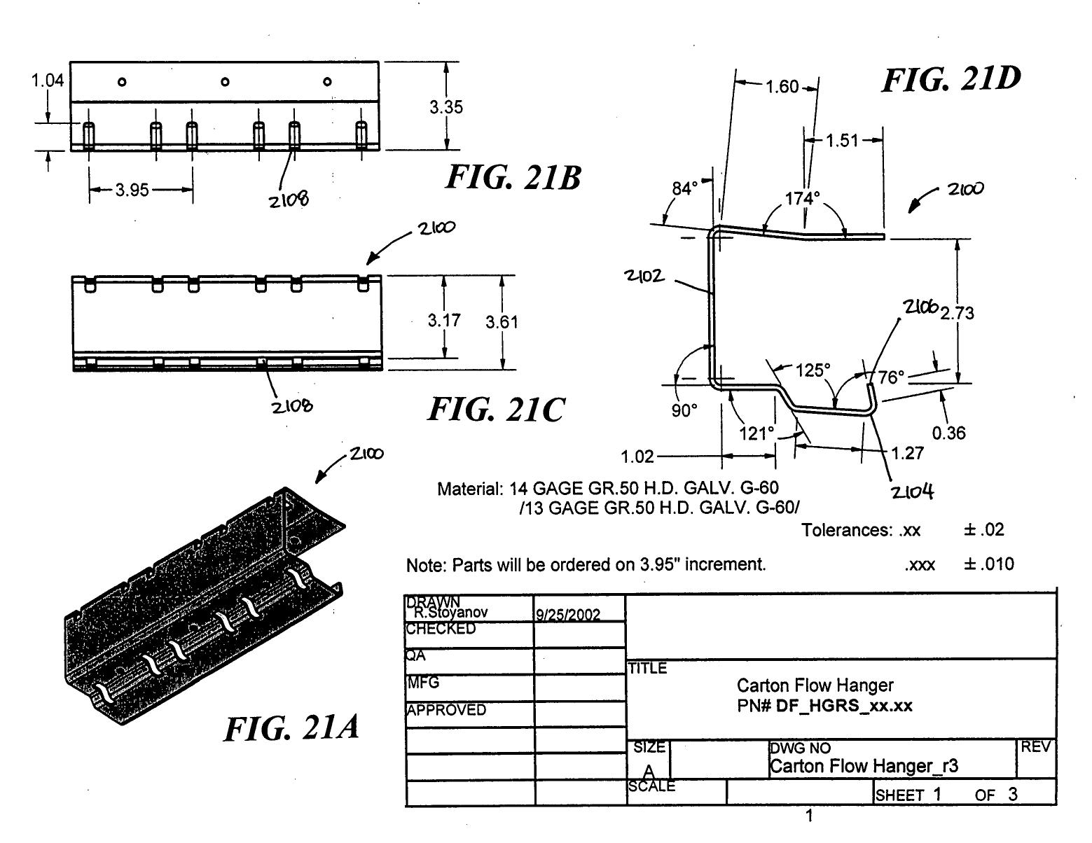

FIG. 2 illustrates a side view of the embodiment shown in FIG. 1. As shown in FIGS. 1 and 2, the track assembly 102 can be supported between beams 118, 120 associated with a support structure, such as a pallet frame, typically (though not necessarily) in an inclined orientation. By use of the track assembly supports 122, 124, the track assembly 102 can be adapted for use with a support structure such as a pallet frame. Examples of an adaptable transfer structure 100 adapted to or otherwise mounted to a pallet frame are shown in FIGS. 5-13, and 25. In the embodiment shown in FIGS. 1 and 2, track assembly supports 122, 124 can be mounted to the beams 118, 120 of the support structure. Track assembly supports 122, 124 can be mounted to any other suitable type of frame, rack, or support structure. An example of a track assembly support is shown and described in greater detail in FIGS. 21A-21D.

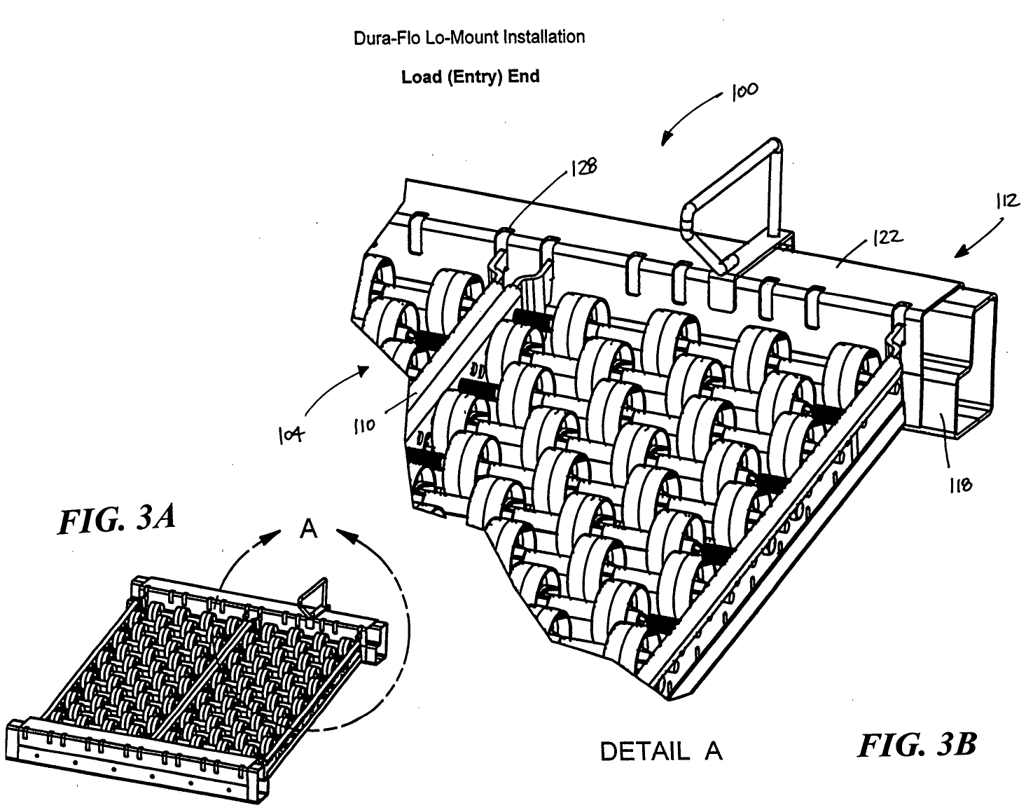

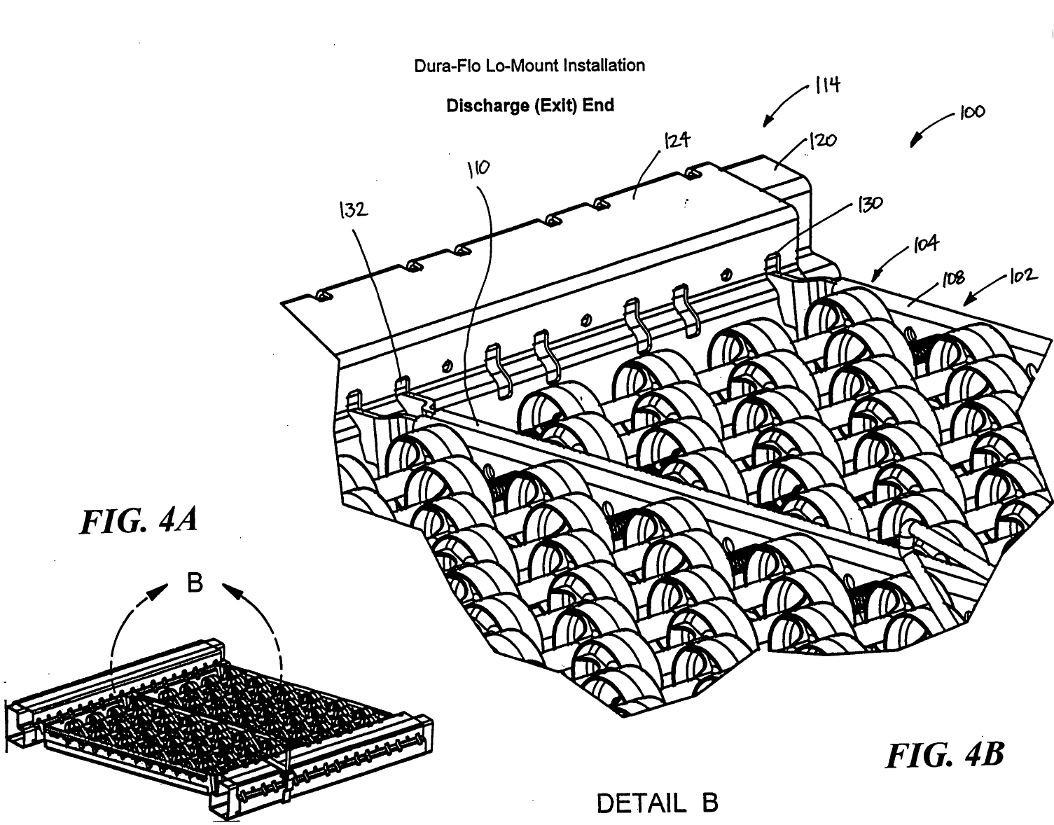

General and detail views of the track assembly 102 mounting to the track assembly supports 122, 124 at the input end 112 and output end 114 are shown in FIGS. 3A, 3B, 4A, and 4B. In FIG. 3B, portions of the track assembly 102 mount to corresponding holes 126, 128 in the track assembly support 122 at the input end 112. Likewise, in FIG. 4B, portions of the track assembly 102 mount to corresponding holes 130, 132 in the track assembly support 124 at the output end 114. Other configurations, devices, or combinations of configurations and devices can be used to assemble or otherwise mount a track assembly between beams in accordance with other embodiments of the invention.

In use, the track assembly 102 shown in FIGS. 1 and 2 can support a load such as a carton (not shown). The carton can comprise a box that is representative of cartons commonly used in picking applications or warehouse and/or distribution environments. A bottom panel (not shown) of the carton can contact an upper portion of some of the wheel assemblies 104.

FIG. 5 illustrates a series of adaptable transfer structures 500, each similar to the adaptable transfer structure 100 shown in FIGS. 1 and 2, mounted to a support structure such as a pallet frame 502. In the example shown, three relatively horizontal rows 504, 506, 508 of transfer structures 500 are implemented, with the transfer structures 500 of each row 504, 506, 508 in a side-by-side or adjacent orientation. Loads 510, 512 of various shapes and sizes are shown on the transfer structures 500. As shown in FIG. 5, various shapes and sizes of loads 510, 512 can be accommodated by the configuration of adaptable transfer structures 500.

The pallet frame 502 shown includes four relatively vertical corner posts 514a, 514b, 514c, 514d and a series of relatively horizontal beams 516, 518 oriented between at least two corner posts 514. For example, in FIG. 5, an input side horizontal beam 516 can be positioned between corner posts 514a and 514b. Also shown in FIG. 5 is output side horizontal beam 518 positioned between corner posts 514c and 514d. Each of the beams 516, 518 can be adapted with a respective track assembly support, such as 122 and 124 in FIGS. 1 and 2. In this embodiment, once the track assembly supports are mounted to the beams 516, 518, one or more transfer structures 500 can be mounted between the beams 516, 518 and adjacent to the track assembly supports.

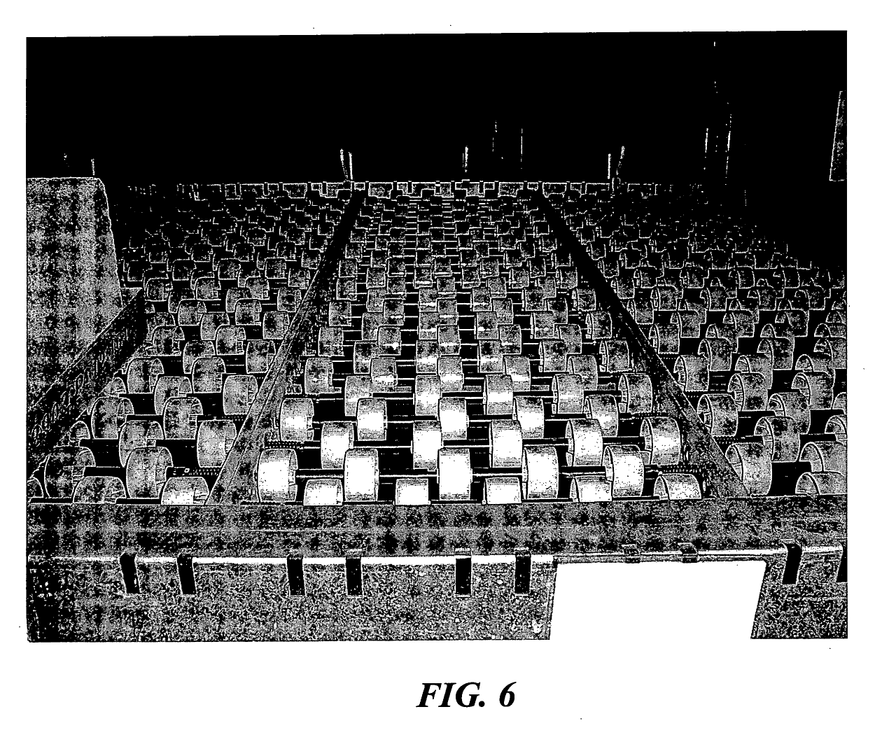

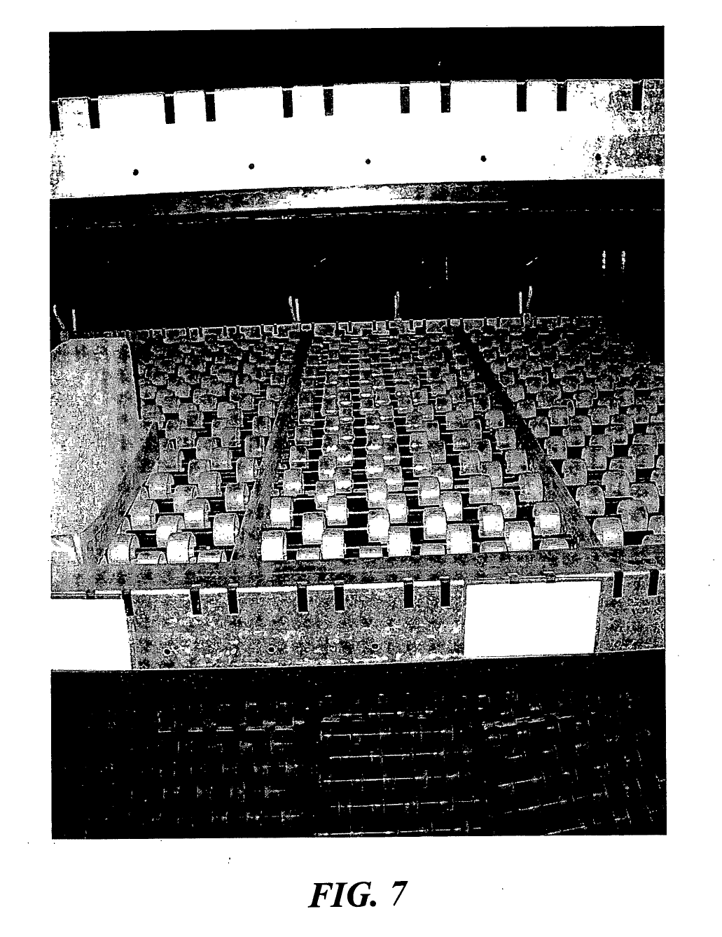

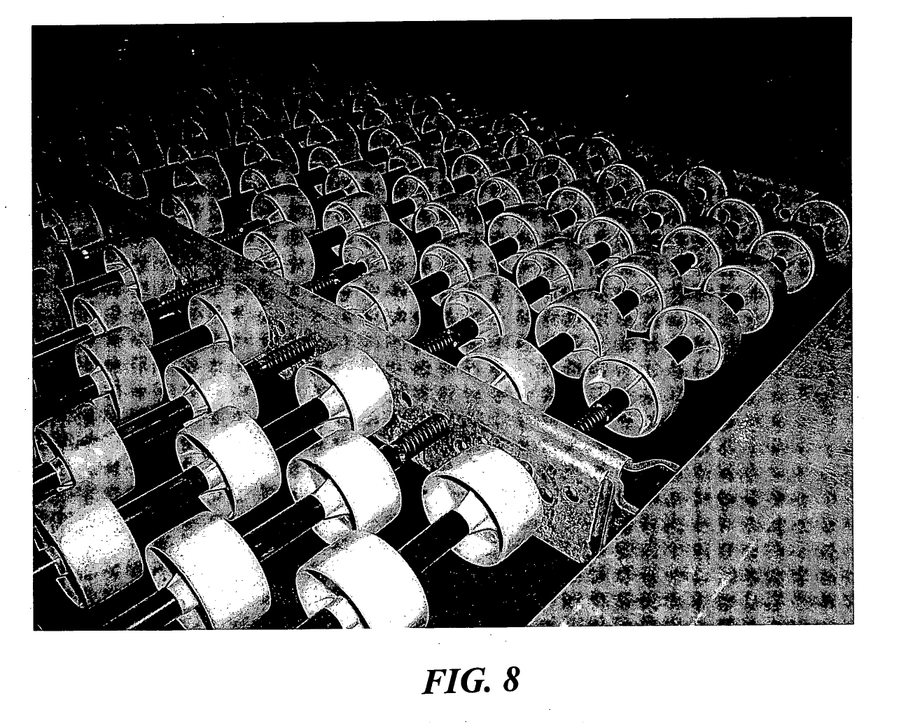

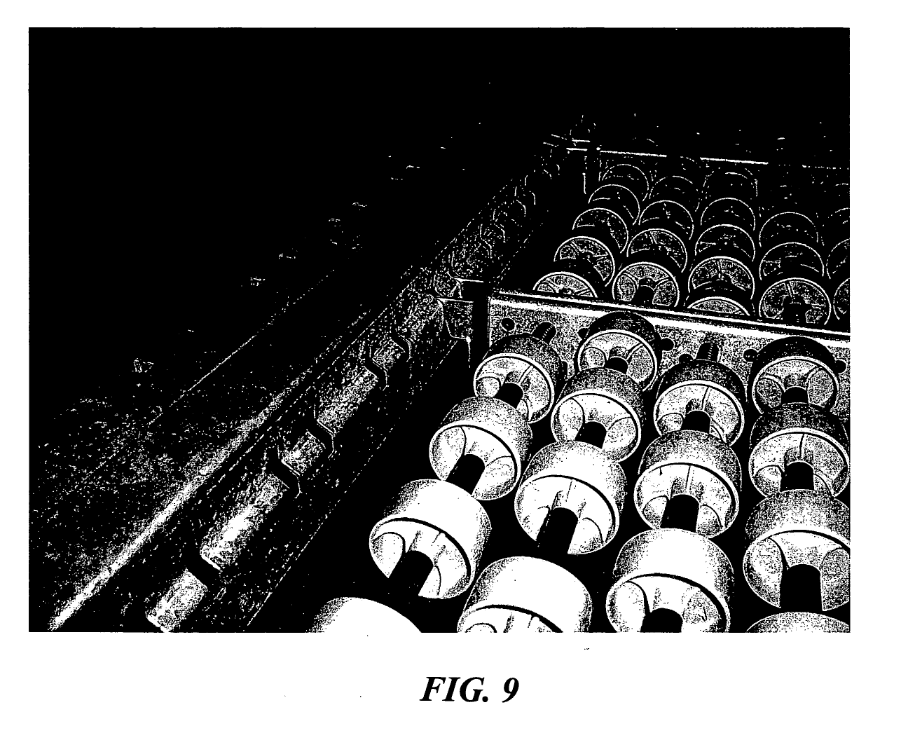

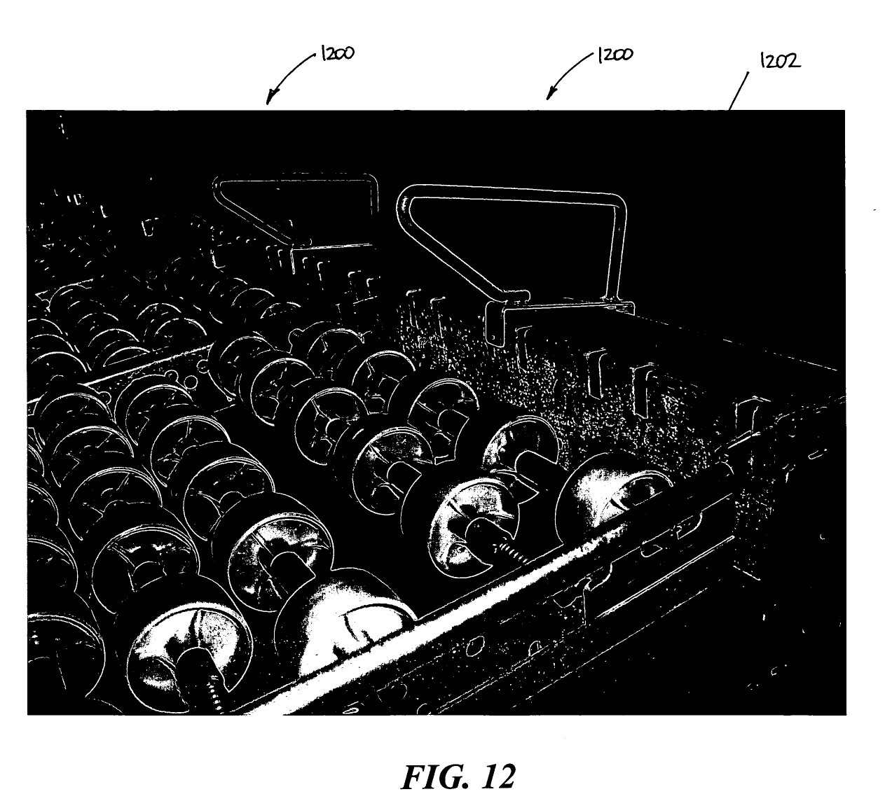

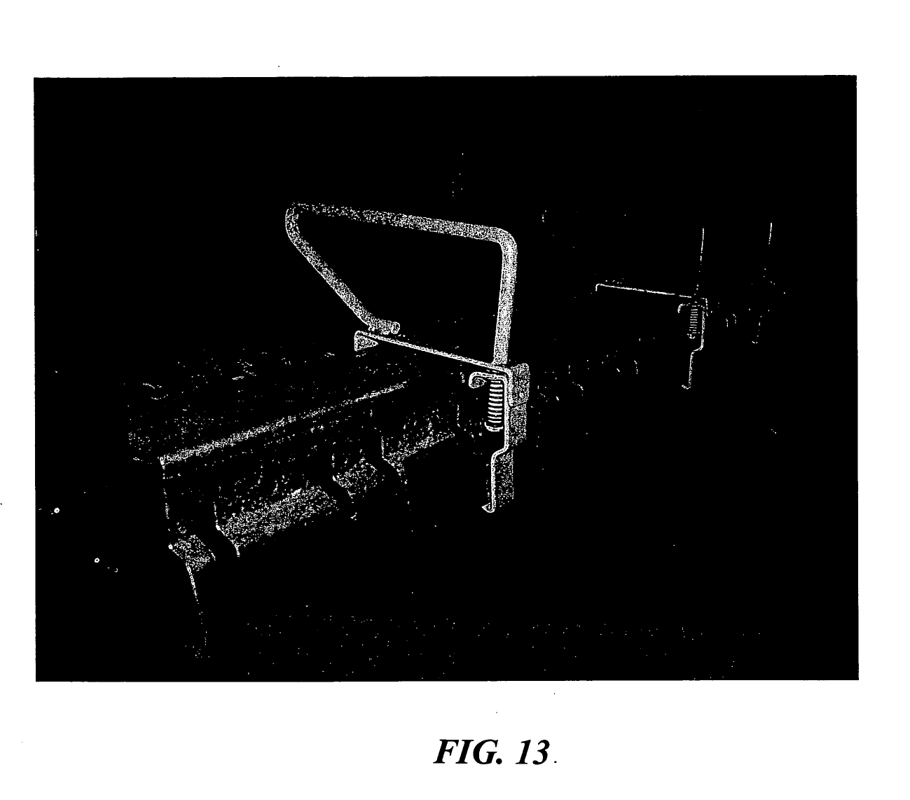

FIGS. 6-13 illustrate detail views of the adaptable transfer structures 500 shown in FIG. 5. Each of the adaptable transfer structures shown in FIGS. 6-13 include a series of wheel assemblies, similar to 104 in FIG. 1, aligned adjacent to and parallel with each other. FIGS. 6 and 7 illustrate front or input side perspective views of the transfer structure 500. FIGS. 8 and 9 illustrate exit or output side perspective views of the adaptable transfer structure 500. FIGS. 10 and 11 illustrate underside perspective views of the adaptable transfer structure 500. FIGS. 12 and 13 illustrate perspective views of the adaptable transfer structure 500 near a front or input end.

FIGS. 12 and 13 also illustrate a series of lane indexers 1200 mounted to the adaptable transfer structures 500. Each lane indexer 1200 can provide a visual indication of predefined widths along the adaptable transfer structures 500 such that a user can organize or otherwise place loads of consistent width, such as similar sized cartons, adjacent to and immediately behind each other on the adaptable transfer structures 500. A lane indexer 1200 can mount to a portion of the adaptable transfer structure 500, such as a track assembly support 1202 which is similar to the track assembly support 122 at the front or input end 114 shown in FIGS. 1 and 2. When desired, each lane indexer 1200 can be positioned, and repositioned, along the length of the track assembly support 1202 to designate one or more “lanes” on the upper surface of the adaptable transfer structure 500.

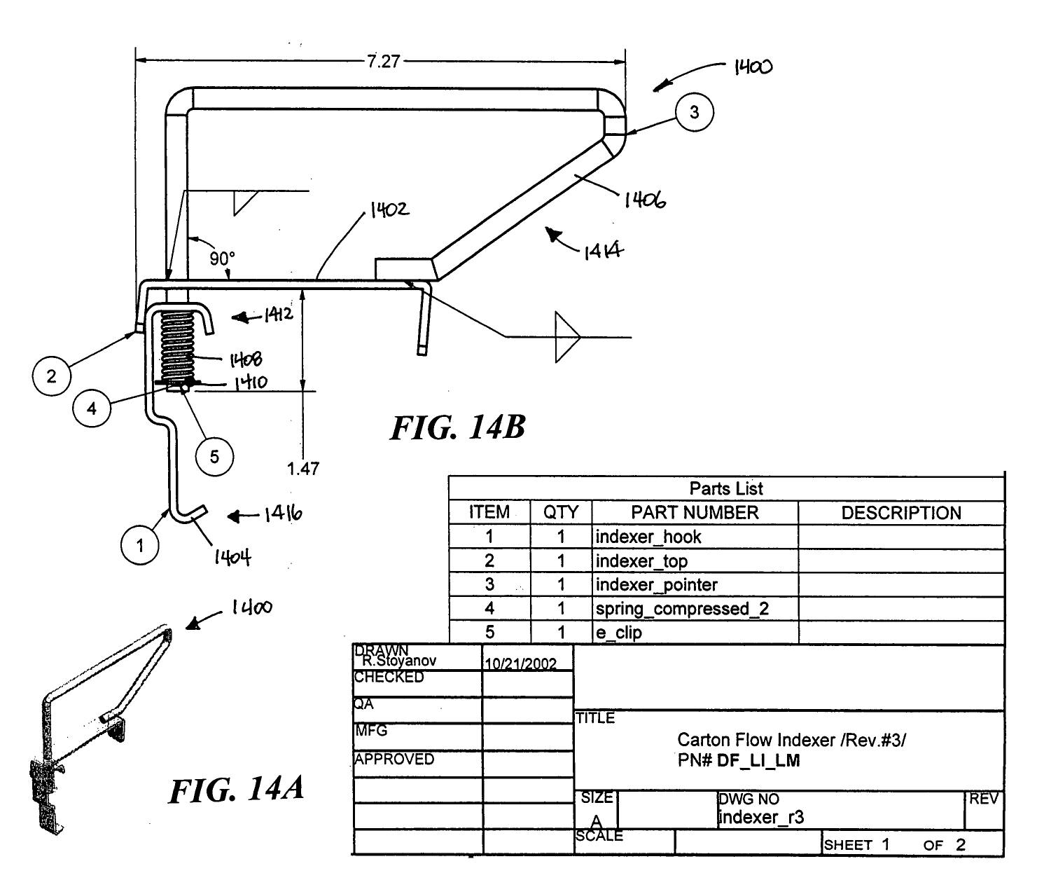

FIG. 14A is a perspective view of one example of a lane indexer 1400, and FIG. 14B shows a side view of the lane indexer in FIG. 14A. The lane indexer 1400 shown can include a base 1402, a hook 1404, a pointer 1406, a spring 1408, and an e-clip 1410. As shown, the base 1402 is a length of flat bar formed in a square C-shaped configuration. Mounted to an upper portion of the base 1402, the pointer 1406 is a length of round bar formed in a trapezoidal-shaped configuration with one end 1412 of the round bar protruding through a portion of the base 1402. In this example, an angled portion 1414 of the pointer 1406 can indicate at least one direction or otherwise provide a visual indicator to a user when the lane indexer is mounted to an adaptable transfer structure, such as a 500 in FIG. 5. Turning back to FIG. 14B, the hook 1404 mounts adjacent to the protruded end 1412 of the pointer 1406, with an extended end 1416 of the hook 1404 curved slightly towards the lower portion of the base 1402. The spring 1408 mounts around a portion of the pointer 1406 between the hook 1404 and the protruded end 1412. The e-clip can secure the position of the spring 1408 adjacent to the protruded end 1412 of the pointer 1406. Other configurations of these or similar components can be used for a lane indexer in accordance with other embodiments of the invention.

When at least one lane indexer, such as 1400 shown in FIG. 14B, is mounted to a track assembly support, such as 1202 in FIG. 12, a “lane” can be designated on the upper surface of a transfer structure, such as 100 in FIG. 1. A lane can be a path along the upper surface of the transfer structure 100 for a carton or other load to travel from the input end 112 to the output end 114 of the transfer structure 100. Each lane indexer 1400 can mount adjacent to the input end 112, and can be moved to various points adjacent to the input end 112 to define different lane widths as needed.

To manually position a lane indexer, such as 1400 in FIG. 14B, with respect to an input end of a transfer structure, such as 100 in FIG. 1, a user can grasp a portion of the pointer 1406 and then generally aim the angled portion 1416 of the lane indexer 1400 towards an output end 114 of the transfer structure 100. The front portion of the base 1402 adjacent to the angled portion 1416 can be positioned adjacent to and mounted on an upper surface of a corresponding track assembly support, such as 122 in FIG. 1. By grasping a portion of the pointer 1406, the user can manually apply a force to press the lower portion of the base 1402 against the upper surface of the track assembly support 122 until a portion of the spring becomes compressed between the hook 1404 and the e-clip 1410 and the extended end 1416 of the hook 1404 is positioned adjacent to the lower surface of the track assembly support 122. When the extended end of the hook 1404 becomes engaged with a portion of the lower surface of the track assembly support 122, the user can manually release the pointer until the user is no longer applying force to the pointer 1406 and the lane indexer 1400 becomes rigidly mounted to the track assembly support 122. As the user manually releases the pointer 1406, the return force of the spring 1408 assists in maintaining the relative position of the hook 1404 and lane indexer 1400 with respect to the track assembly support 122.

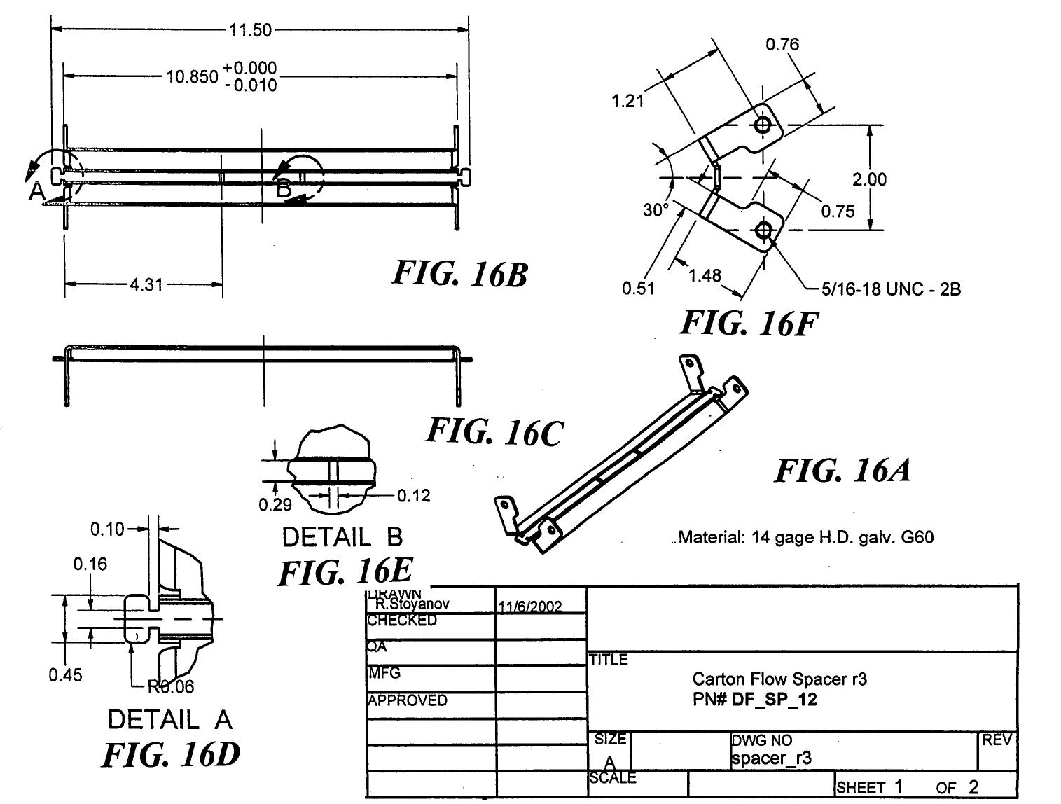

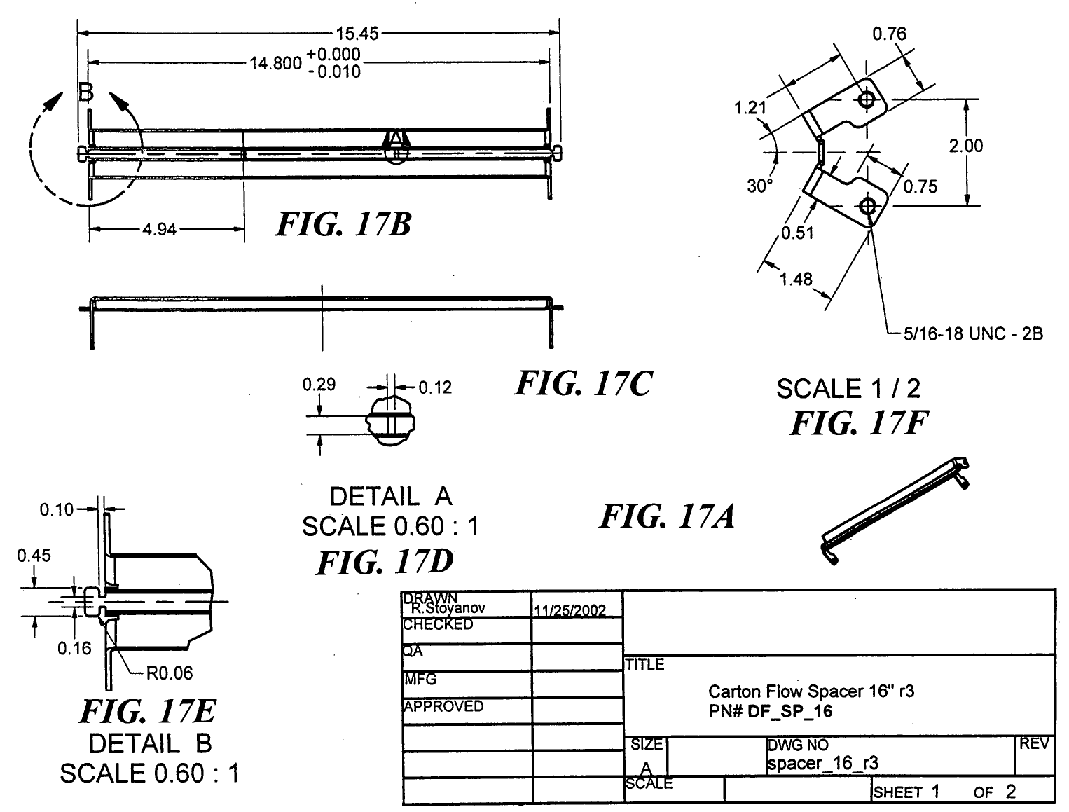

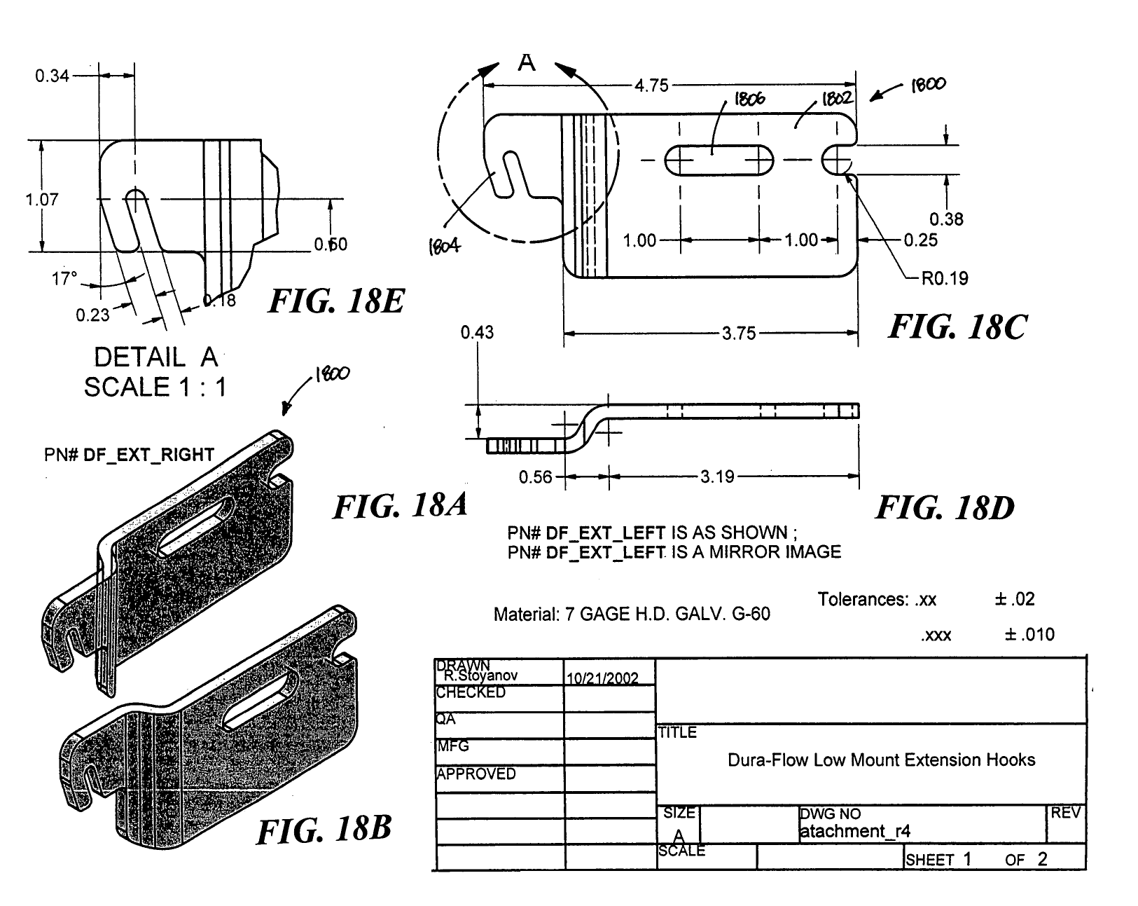

FIGS. 15-18 illustrate components for a track assembly in accordance with an embodiment of the invention. FIGS. 15A, 15B, and 15C illustrate a respective perspective, side and end view of a profile 1500, similar to that shown as 108, 110 in FIGS. 1 and 4. The profile 1500 shown can include a series of profile mounting holes 1502, axle mounting holes 1504, and a C-shaped body 1506. The profile mounting holes 1502 can be aligned with corresponding profile mounting holes of another profile. As shown in FIGS. 10 and 11, spacer bars 1000 can be fastened between selected corresponding pairs of profile mounting holes 1002. Other examples of spacer bars are illustrated in FIGS. 16A and 17A. In other embodiments of the invention, spacer bars can be threaded rods fastened between selected pairs of profile mounting holes as necessary to secure or otherwise position the profiles 108, 110 relative to each other. In the embodiment shown in FIG. 15, axle mounting holes 1504 of profile 1500 can be aligned with corresponding axle mounting holes of another profile for receiving axles of wheel assemblies 104. The C-shaped body 1506 can receive various connecting devices adjacent to the ends of the profile 1500 to connect the profile to other components of an adaptable transfer structure 100, such as a track assembly support 122, 124. Connecting devices can include splice bars, angle splice bars, extension hooks, connecting bars, mounting bars, stops, impact trays, and other suitable devices in accordance with embodiments of the invention. For example, suitable connecting devices to connect profile 1500 to a track assembly support, such as 122, 124, are extension hooks 1800, 1802 shown and described in FIGS. 18A, 18B, 18C, 18D, and 18E.

FIGS. 18A and 18B illustrate perspective views of a right-hand and left-hand extension hook, respectively, for connecting a profile to a track assembly support. FIGS. 18C and 18D illustrate a side and end view of a left-hand extension hook 1800, and FIG. 18E shows detail A of FIG. 18C. The extension hooks 1800, 1802 shown each include a body 1802, a hook 1804, and an axle mounting hole 1806. The body 1802 can be shaped and sized to fit within or adjacent to a profile, such as fitting within the C-shaped body 1506 of the profile 1500 shown in FIG. 15. Adjacent to an end of the body 1802, the hook 1804 extends from the body 1802 and can be shaped and sized to fit within a corresponding hole in a track assembly support, such as 122, 124 in FIGS. 1 and 2, or beam of a support structure. Within the central portion of the body 1802, an axle mounting hole 1806 is sized to receive a portion of an axle of a wheel assembly, such as a 104 of FIGS. 1 and 2. When the extension hook 1800 is inserted within a portion of a profile, such as the C-shaped body 1506 of profile 1500, the hook 1804 extends from the profile 1500 and can connect to a track assembly support, such as 122, 124 in FIGS. 1 and 2, or beam of a support structure. The position of the hook 1804 and body 1802 can be fixed or otherwise secured by mounting an axle of a wheel assembly 104 through the axle mounting hole 1806 and through a concentrically aligned axle mounting hole of a profile, such as axle mounting hole 1504 shown in FIG. 15. Mounting of the axle with respect to the extension hook, and mounting of the extension hook with respect to a track assembly support are described in greater detail below. Various alternative adapters, devices, hooks, and bars can be used to for connecting a profile to a track assembly support. For example, one arrangement shown in FIGS. 34 and 35 utilizes one or more entry hooks and corresponding exit hooks, wherein each of the hooks can extend from the transfer structure and can mount to a portion of the track assembly support. This particular embodiment is further described below.

FIGS. 19A, 19B, 20A and 20B illustrate examples of a wheel assembly in accordance with embodiments of the invention. FIGS. 19A and 20A show perspective views of respective wheel assemblies 1900, 2000, and FIGS. 19B and 20B show side views of the wheel assemblies 1900, 2000. As described above in FIG. 1, each wheel assembly 104 can be manually removed from a track frame 108, 110 if repair or replacement is needed. In the examples shown, the design of the track assembly 102 and wheel assemblies 104 permits a user to manually replace a wheel assembly 104 without special tools or equipment, or without extensive disassembly of the transfer structure 100.

As shown in FIGS. 19A, 19B, 20A and 20B, each wheel assembly 1900, 2000 can include a multi-wheel axle 1902, 2002, multiple polycarbonate resin wheels 1904, 2004 rotatably mounted on the axle 1902, 2002, and a spring 1906, 2006 rotatably mounted adjacent to one end of the axle 1902, 2002. The wheels 1904, 2004 of a given wheel assembly can be mounted along the axle 1902, 2002 in a row extending transverse to the track flow direction. An example of a suitable wheel is shown and described in U.S. application Ser. No. 09/956,253, entitled “Freewheel Flow Track Systems,” filed on Sep. 20, 2001. Springs 1906, 2006 can be constructed from steel, but may be constructed from any other suitable metal or material, or a combination thereof.

As shown in FIGS. 19A and 19B, an axle 1902 can include a shaft portion 1908, one head portion 1910 adjacent one end of the shaft portion 1908, a second head portion 1912 adjacent an opposing end of the shaft portion 1908, and a wheel securing means 1914. The axle 2002 in FIGS. 20A and 20B can have similar features and components as the axle 1902 shown in FIGS. 19A and 19B. The wheel securing means 1914 shown can include, but is not limited to, a mechanical dimple in the axle 1902, a locking device, a nut, a bead, or any other suitable device that can secure the position of a wheel 1904 relative to the axle 1902. Axles 1902 can be constructed from steel, but may be constructed from any other suitable metal or material, or a combination thereof. The shaft portions 1906 can be coated with a lubricant coating 1916 that is applied to and bonded with the shaft portion 1908. For example, a suitable lubricant coating can be fluorocarbon-based or Teflon-based, and can be heated to a relatively high temperature to fix to and bond with the shaft portion.

The wheel assembly 1900 of FIGS. 19A and 19B can also include one or more axle spacers 1918. The wheel assembly 2000 in FIGS. 20A and 20B can have similar features and components of the wheel assembly in FIGS. 19A and 19B. Axle spacers 1918 can be mounted on the axle 1902 between consecutive or otherwise adjacent wheels 1904 of the assembly 1900. The axle spacers 1918 can secure each of the wheels 1904 in a desired position along the axle 1902. Various numbers and/or sizes of spacers 1918 can be used in each wheel assembly 1900, and the arrangement of the spacers 1918 and wheels 1904 in a wheel assembly 1900 can be varied to change the position of the wheels 1904 along the axle 1902 as desired. The spacers 1918 can include spacer slits to allow the spacers to be mounted to, such as snapped onto and off of, the axle 1902, thus facilitating the task of changing the positions of the wheels 1904 along the axle 1902.

The wheel assemblies 1900, 2000 shown can be installed in a similar manner with respect to a track assembly, shown as 102 in FIG. 1, wherein the axle 1902, 2002 extends between profiles, such as 134 and 136 in FIGS. 1 and 2, or 1500 in FIG. 15, transverse to the track flow direction. With respect to FIGS. 19A and 19B, the head portions 1910, 1912 of the axle 1902 can be mounted within axle mounting holes such as 1504 in FIG. 15. To mount the head portions of an axle 1902 in axle mounting holes, the head portion of the axle adjacent to the spring 1906, in this example head portion 1910, is first inserted into an axle mounting hole of a first profile, such as 108. The spring 1906 is compressed between a surface of the profile 108 and the wheel securing means 1914 or wheel 1904, until the opposing or second head portion of the axle, in this example head portion 1912, can be inserted into an axle mounting hole of a second, or opposing profile, such as 110. When the compression force on the spring 1906 is released, a return force generated by the spring 1906 causes the spring 1906 to remain in contact with the profile 108 and in a position between the surface of the profile 108 and the wheel securing means 1914 or wheel 1904. In this manner, the wheel assembly 1900 of FIGS. 19A and 19B can be manually installed relatively quickly and without special tools or equipment. The wheel assembly 2000 of FIGS. 20A and 20B can be installed in a similar manner.

In some instances, the head portion 1910 and second head portion 1912 of an axle 1902 can extend through more than one axle mounting holes at a time, such as through the axle mounting hole 1504 in a profile 1500 and a concentrically aligned axle mounting hole 1806 in a extension hook 1800. In this manner, the axle 1902 can connect components of a transfer structure 100 together, such as a profile 1500 and an extension hook 1800.

To remove a wheel assembly, such as 1902, from a track assembly, such as 102, the spring 1906 is compressed to permit the axle 1902 to flex or bow slightly until at least one end of the axle 1902 can be removed from one of the profiles, such as an axle mounting hole in profile 108. After at least one end of the axle 1902 is removed from one of the profiles, such as 108, the other end of the axle 1902 can be removed from the opposing profile, such as profile 110. In this manner, the wheel assembly 1900 of FIGS. 19A and 19B can be manually removed and replaced relatively quickly and without special tools or equipment. The wheel assembly 2000 of FIGS. 20A and 20B can be removed and replaced in a similar manner.

As shown in FIGS. 1 and 2, wheels within a given wheel assembly 104 can occupy unique transverse positions with respect to the wheels of adjacent wheel assemblies, wherein the transverse positions are measured in the direction transverse to the track flow direction. Positioning the wheels in this manner can generally permit more wheels to contact the bottom of a load such as a carton.

Multiple wheels across one or more axles can provide a relatively wide track-type assembly. This type of configuration can provide relatively high load capacity for supporting heavy loads such as multiple cartons of varying sizes and shapes, and can provide relatively reliable and efficient flow through the use of multiple wheels.

In FIGS. 21A, 21B, 21C and 21D, perspective, side, top, and end views of a track assembly support 2100 similar to the track assembly supports 122, 124 in FIGS. 1 and 2 are shown respectively. The track assembly support 2100 shown can include a U-shaped body 2102, a support portion 2104, a securing means 2106, and a series of support holes 2108. The U-shaped body 2102 can be shaped to generally conform with a surface of a beam for a support structure, such as the external surface of beams 118, 120 for a pallet rack shown in FIGS. 1-4. The support portion 2104 can extend from the U-shaped body 2102, and provide support for profiles of a track assembly, such as an extension hook 1800 connected to a profile 1500 described above. When the U-shaped body 2102 is fit over a portion of a beam for a support structure, such as the external surface of beams 118, 120 for a pallet frame, the securing means 2106 can secure the position of the track assembly support 2100 with respect to the beam 118, 120. In the example shown, the securing means 2106 is a L-shaped angle that conforms with an angled surface of a beam for a pallet frame. Other suitable securing means can include, but are not limited to, adhesives, bolts, angled devices, grips, pressure-type devices, and any other suitable device or method that can secure the position of a track assembly support 2100 to a beam of a support structure such as a pallet frame. One or more of the support holes 2108 can then be utilized by the profiles of a track assembly, such as connecting the hook 1804 of the extension hook 1800 described above into a support hole 2108. In this manner, the track assembly support can be manually positioned on a support structure relatively quickly and without special tools or equipment. Furthermore, profiles of a track assembly can also be manually positioned relative to the track assembly support and support structure relatively quickly and without special tools or equipment.

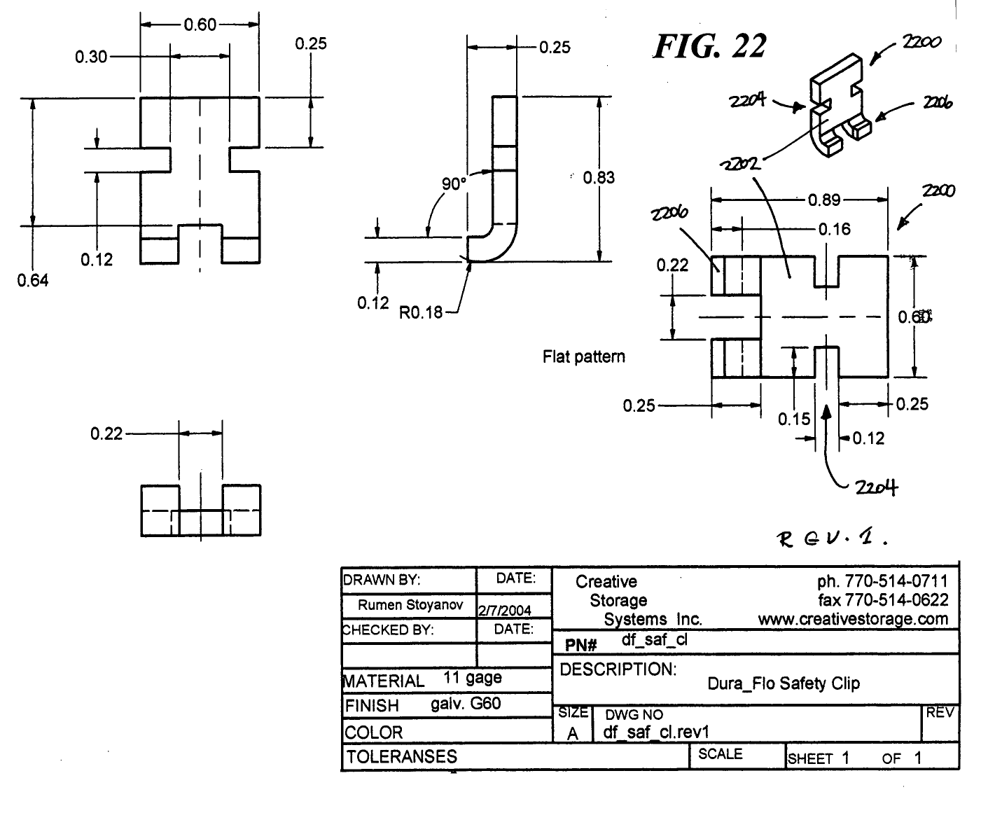

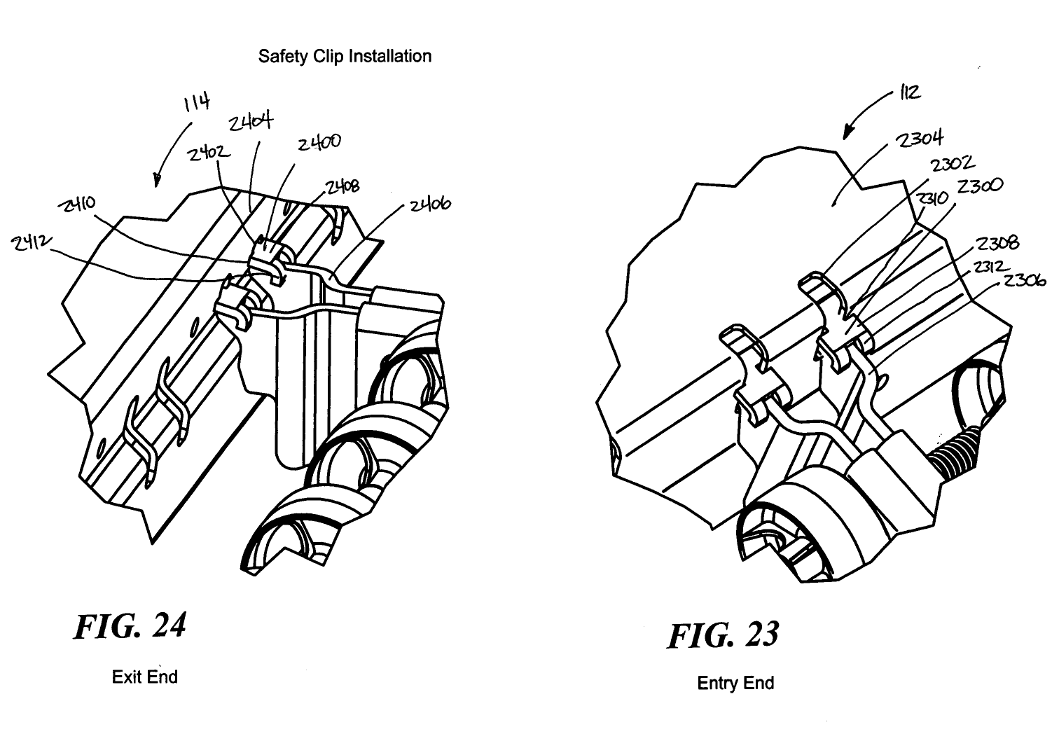

FIGS. 22A, 22B, 22C, 22D, and 22E show perspective, front, rear, end, and side views of a safety clip 2200 for securing a position of a track assembly with respect to a track assembly support. The safety clip 2200 can include a body 2202, support indentations 2204, and profile supports 2206. FIGS. 23 and 24 illustrate perspective views of the installation of a safety clip, such as 2200 in FIG. 22A, with respect to track assemblies, shown in FIG. 1 as 104, and track assembly supports such as 122, 124, at both the input end 112 and output ends 114 of a transfer structure 100 shown in FIGS. 1-4. As shown in FIGS. 23 and 24, each of the safety clips 2300, 2400 can be installed in a support hole 2302, 2402 of a track assembly support 2304, 2404 to secure the position of the profile 2306, 2406. A portion of the body 2308, 2408 of the safety clip 2300, 2400 can be inserted in the support hole 2302, 2402, and then the body 2308, 2408 can be rotated slightly until a portion of the track assembly support 2304, 2404 fits tightly within the support indentations 2310, 2410. When the safety clip 2300, 2400 is positioned in this manner, the profile supports 2312, 2412 should be positioned adjacent to a portion of the profile 2308, 2408, such as the hook extension 1800 of a profile shown in FIG. 18A or 18B described above, wherein the profile 2308, 2408 is firmly supported against the track assembly support 2304, 2404. In this manner, the position of the track assembly can be secured with respect to the support structure and/or the track assembly support.

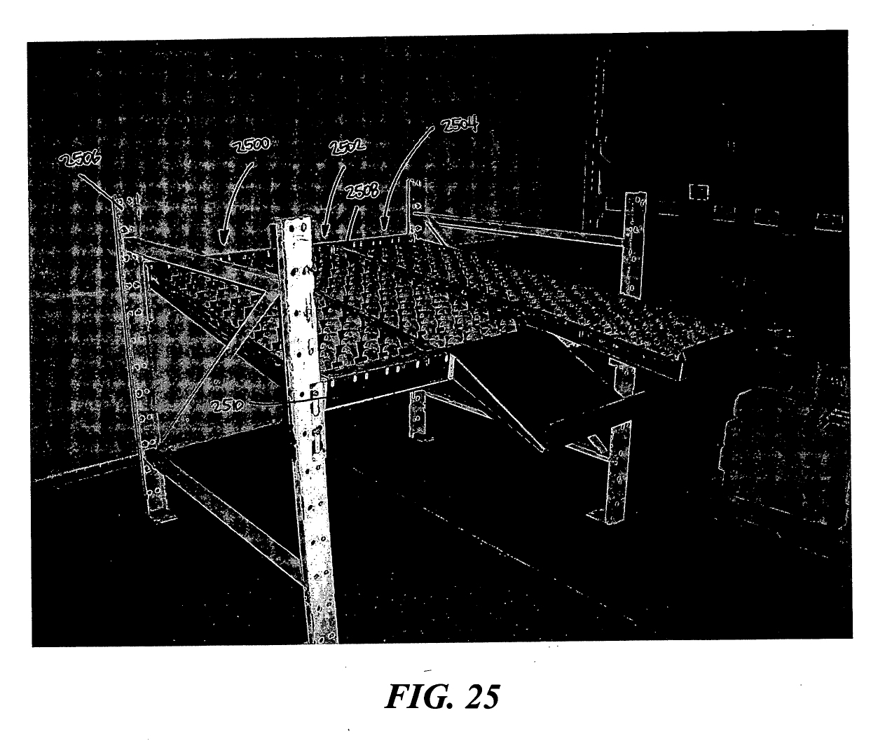

FIG. 25 illustrates an example of at least three embodiments 2500, 2502, 2504 of an adaptable transfer conveyor such as an adaptable freewheel flow system. The embodiments 2500, 2502, 2504 shown can be adapted to mount to a pallet frame 2506 or any other suitable type of pallet rack, frame, or other support structure. One embodiment 2500, positioned towards the left portion of the pallet frame 2506 shown, mounts between beams 2508, 2510 of the pallet frame 2506. This embodiment is similar to the embodiment described above in FIGS. 1 and 2, and 5-13. Implementations of this particular embodiment are manufactured and distributed by Creative Storage Systems, Inc. of Kennesaw, Ga. under the brand name “Lo-Mount™.” This particular embodiment can be implemented for instances where loads such as cartons are to transported from an input end to an output end, such as from beam 2508 to beam 2510.

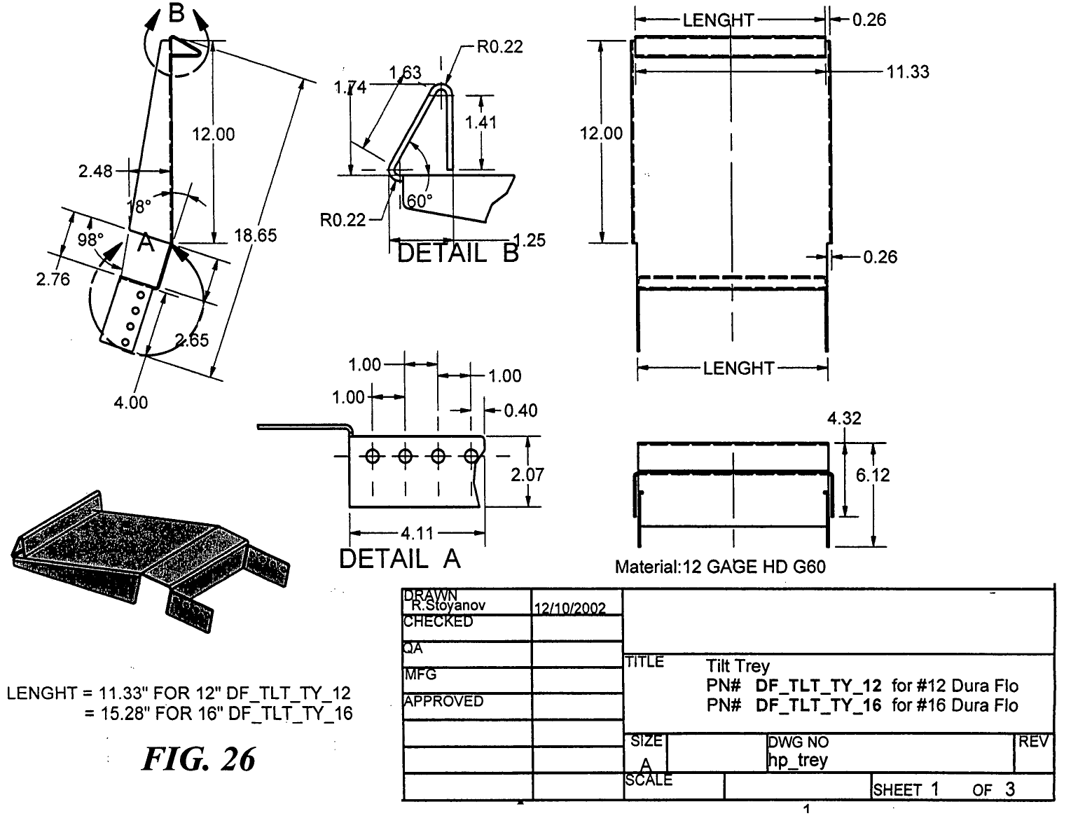

A second embodiment 2502, shown between the leftmost embodiment 2500 and the rightmost embodiment 2504, shows the addition of an associated output end device, such as a tilt tray. An example of a tilt tray is shown and described in FIGS. 26A, 26B, 26C, 26D, 26 E, and 26F. Other similar types of exit end devices can be utilized with these and other embodiments of the invention. This particular embodiment can be implemented for instances where loads such as cartons are to transported from an entrance end and away from an exit end, such as from beam 2508 to a position past beam 2510.

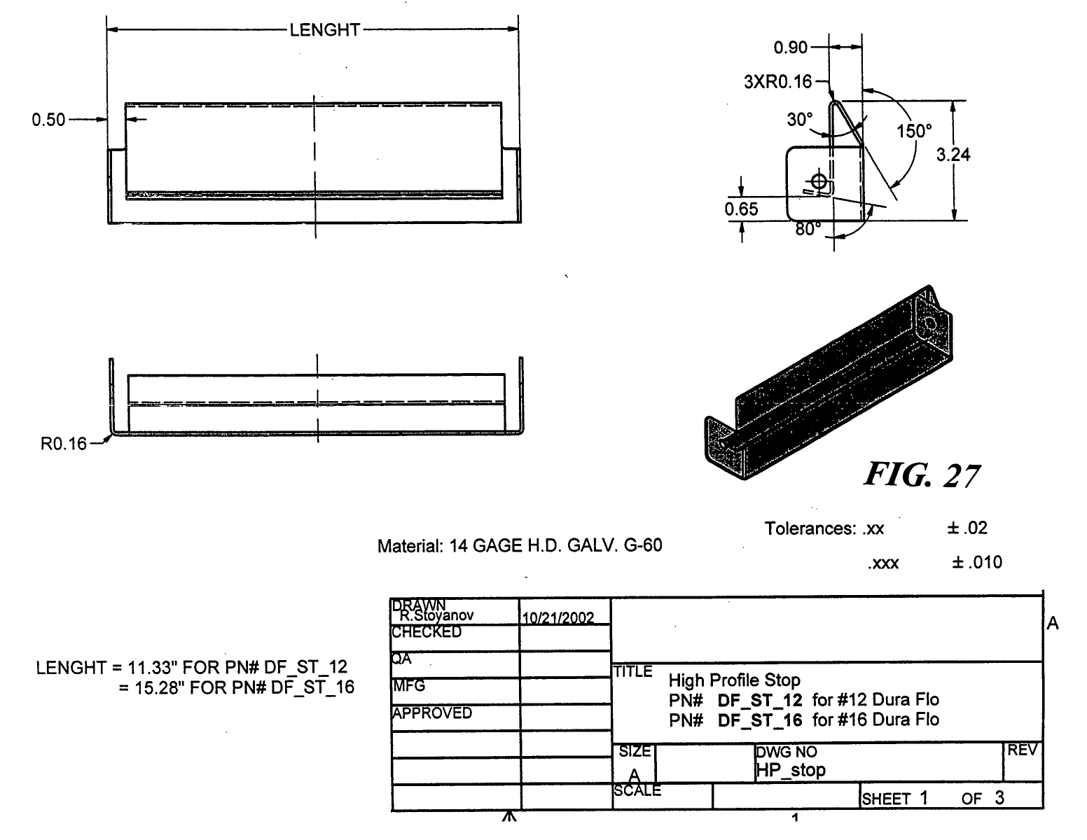

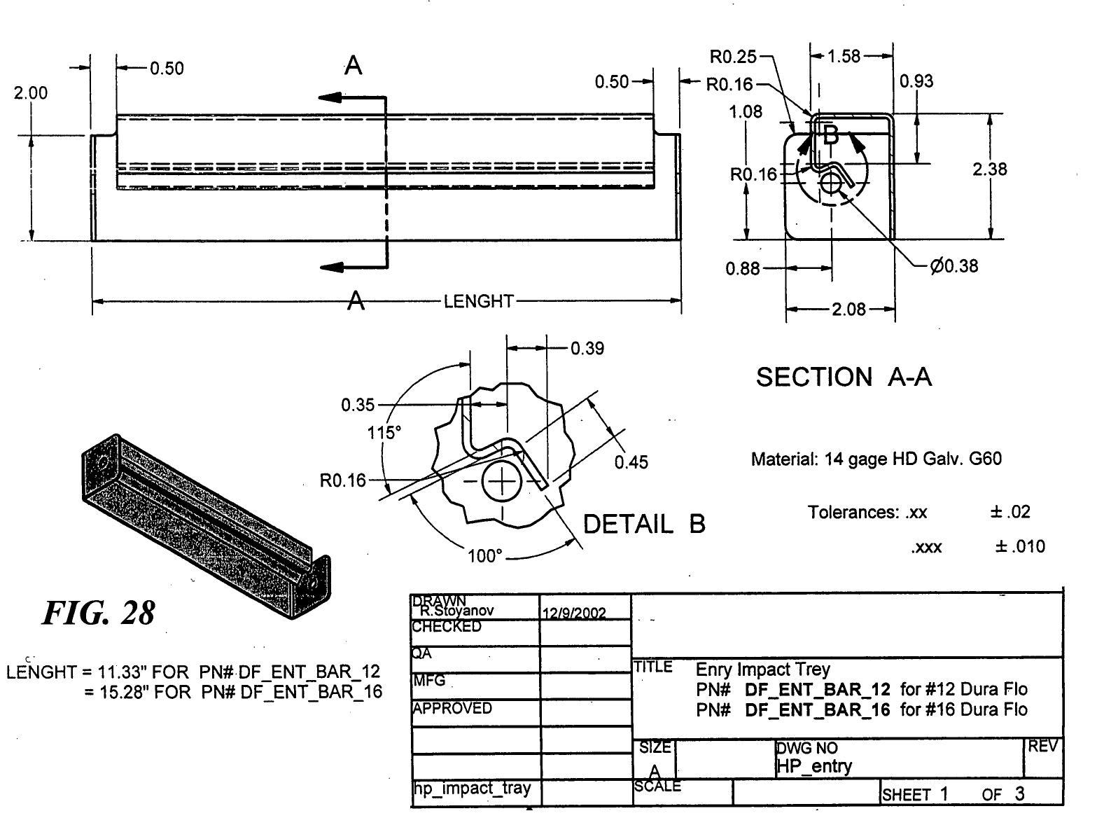

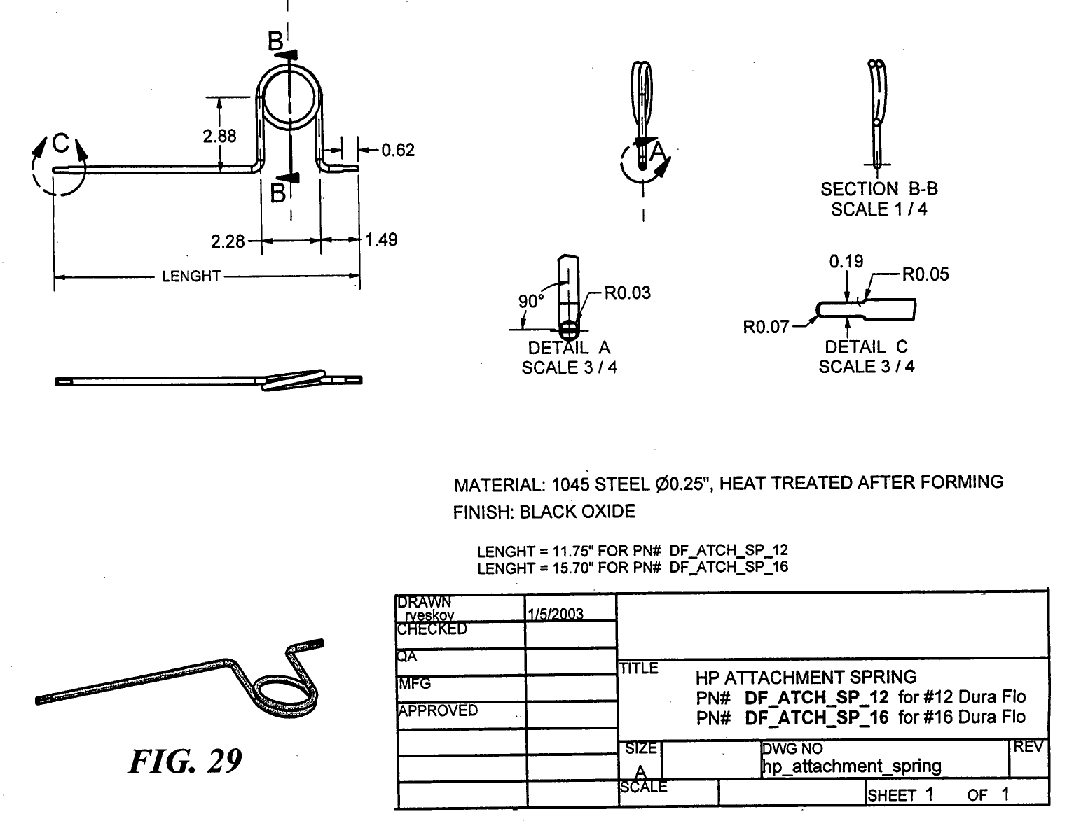

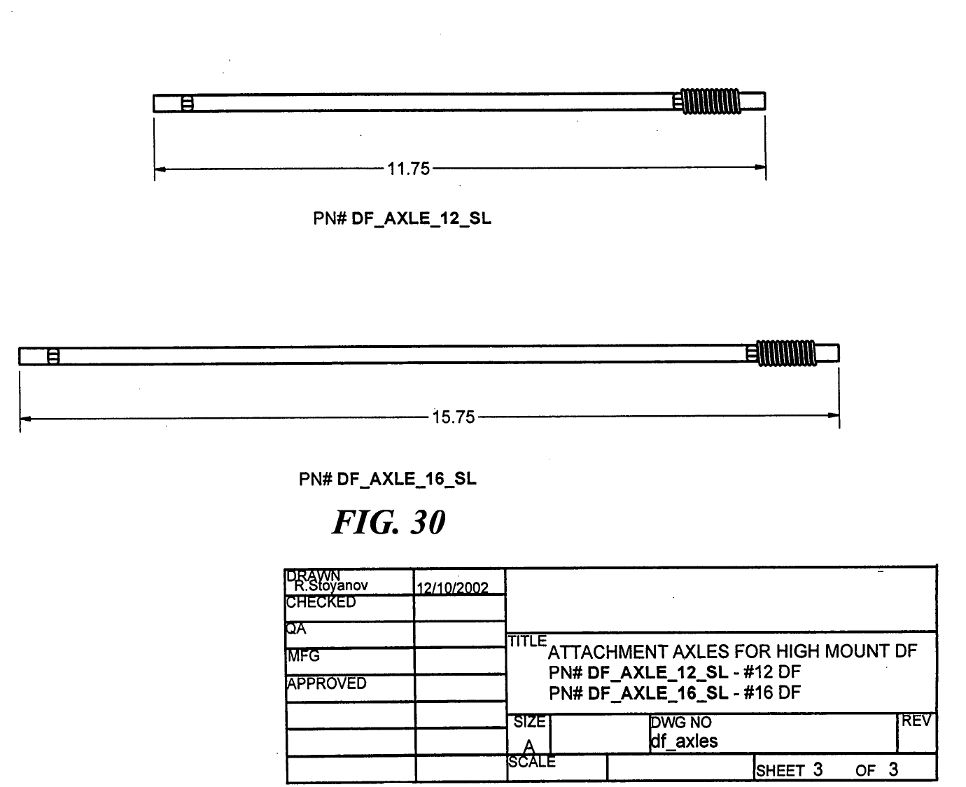

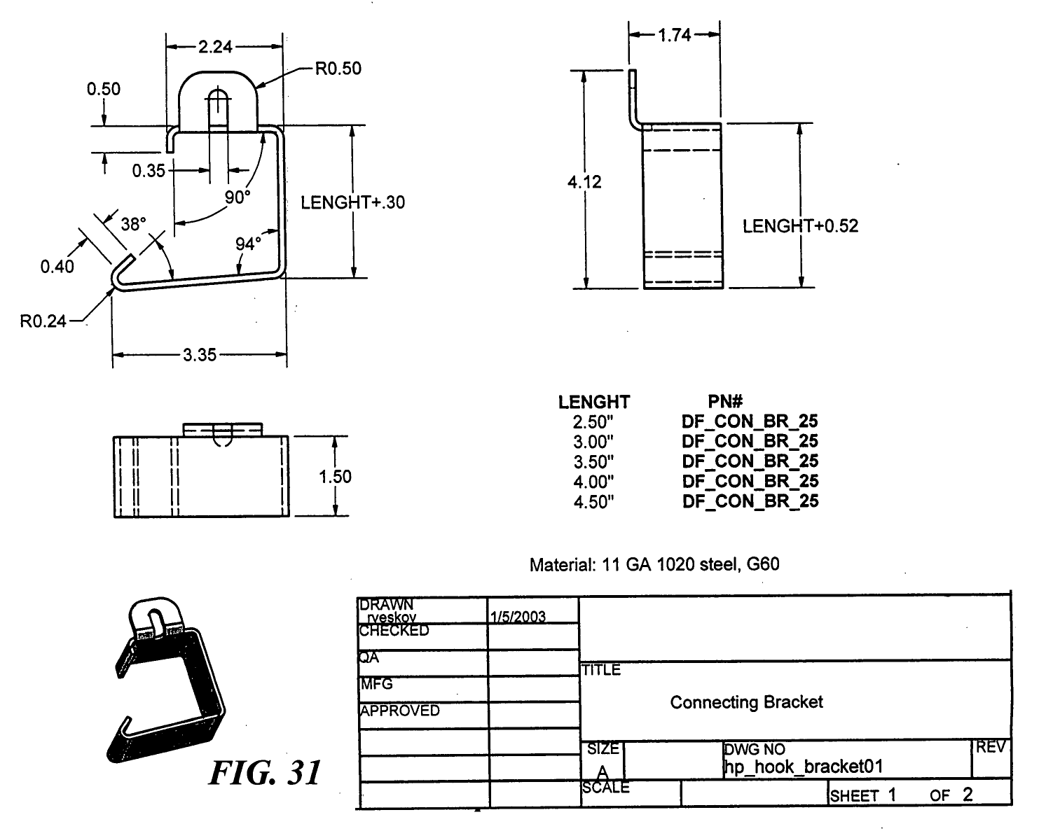

Another embodiment 2504, positioned towards the right portion of the pallet frame 2506, mounts on an upper surface of at least one beam 2510 of the pallet frame 2506. Implementations of the second embodiment are manufactured and distributed by Creative Storage Systems, Inc. of Kennesaw, Ga. under the brand name “Hi-Mount™.” This particular embodiment can be implemented for instances where loads such as cartons are to transported from an entrance end and away from an exit end, such as from beam 2508 to a position past beam 2510. Various types of exit end devices can be utilized, such as a high profile stop shown in FIG. 27, and an entry impact tray shown in FIG. 28. Associated clips, attachment springs, attachment axles, connecting brackets, and other suitable devices may be needed to connect an exit end device to a transfer structure in accordance with various embodiments of the invention. Examples of these associated devices are illustrated in FIGS. 29-31.

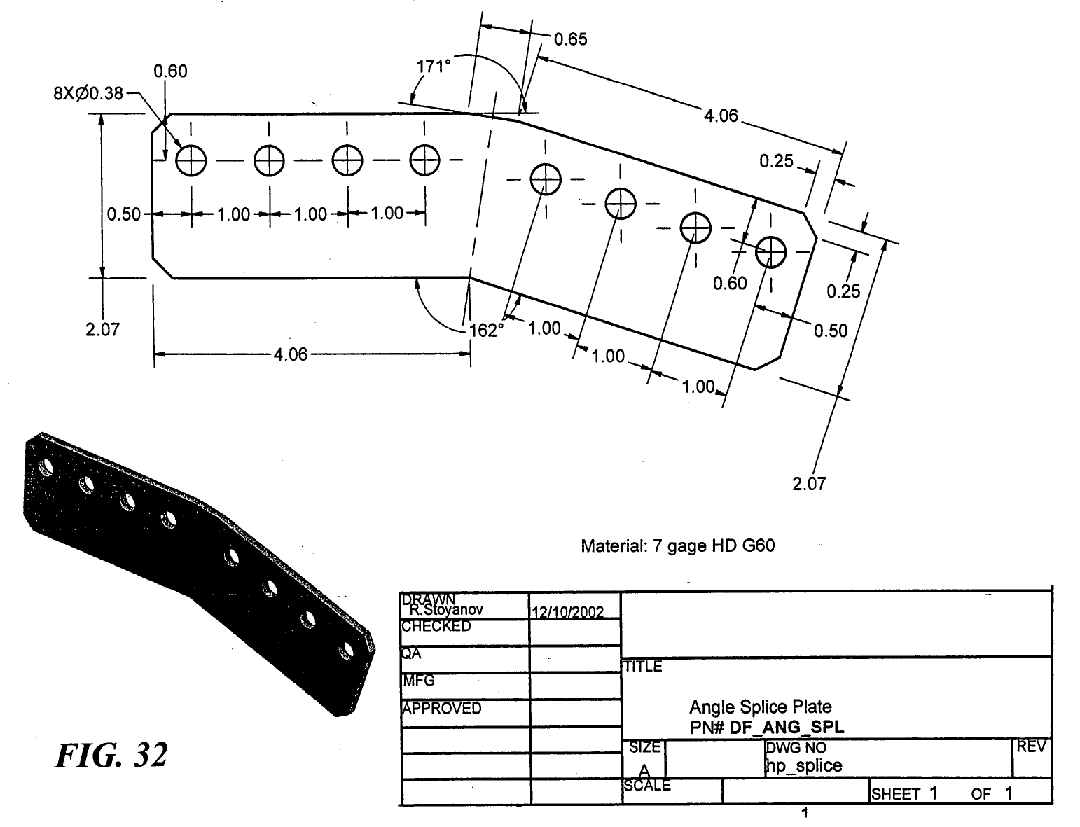

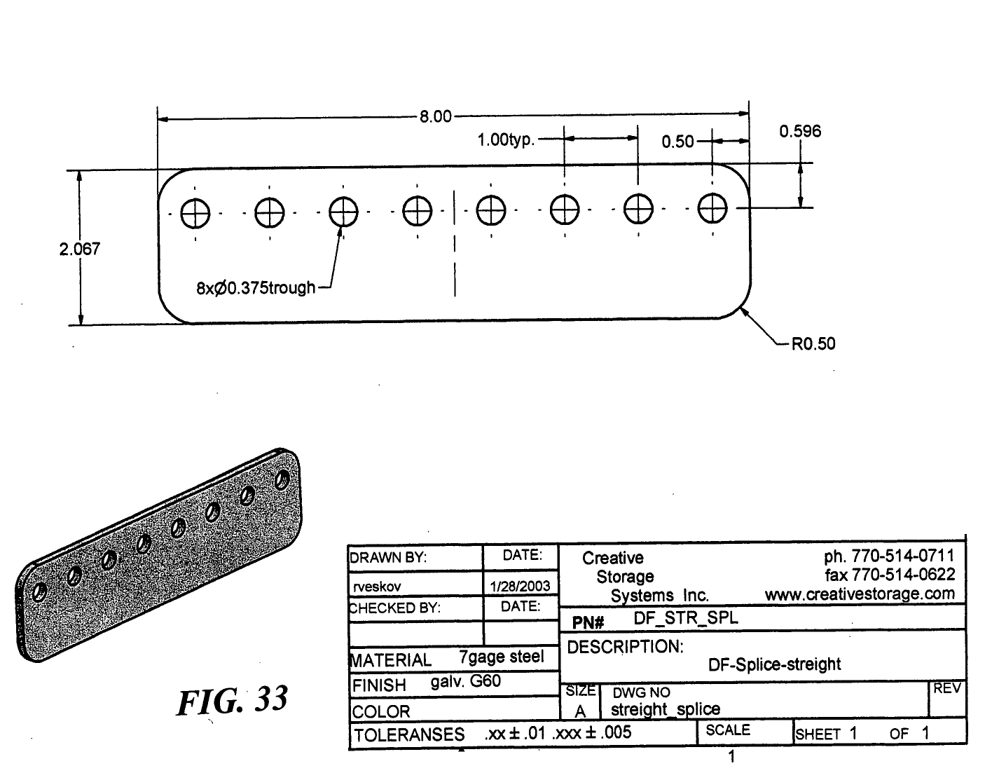

Various lengths for an adaptable transfer conveyor can be made as desired by connecting track assemblies together. For example, using connecting devices such as a splice plate or an angle splice plate, two or more track assemblies can be connected together as needed. Examples of connecting devices are shown in FIGS. 32 and 33.

FIGS. 34 and 35 show another embodiment of an adaptable transfer structure. The adaptable transfer structure 3400 shown utilizes one or more entry hooks 3402 and exit hooks 3404 extending from a corresponding profile 3406 and mounting to a portion of an adjacent track assembly support 3408, 3410. Each of the profiles 3406 in this embodiment can include a tubular-shaped component 3412 along the upper portion of the profile 3406. Each of the entry hooks 3402 and exit hooks 3404 can mount within and extend from the tubular component 3412 as shown. In the embodiment shown, the shape and configuration of the entry hooks 3402 and exit hooks 3404 can affect the angle the transfer structure is positioned at relative to the adjacent track assembly supports 3408, 3410. For example, an entry or input end adjacent to the entry hooks 3402 can be elevated relatively higher than an exit or output end adjacent to the exit hooks 3404. Examples of entry hooks 3402 and exit hooks 3404 are shown as 3600 and 3700 in FIGS. 36 and 37 respectively.

In FIG. 36, an example of an entry hook 3600 is shown as a C-shaped square bar. FIG. 37 shows an example of an exit hook 3700 as a square bar with multiple bends or angles. Both types of hooks 3600, 3700 shown can extend from an adaptable transfer structure, such as 3400, and mount to an adjacent track assembly support, such as 3408, 3410. Both examples of the entry hook 3600 and exist hook are shown by way of example, and can have alternative configurations, shapes and sizes in accordance with the invention.

While the above description contains many specifics, these specifics should not be construed as limitations on the scope of the invention, but merely as exemplifications of the disclosed embodiments. Those skilled in the art will envision many other possible variations that are within the scope of the invention.

The invention I claim is:

1. An adaptable transfer structure for conveying a load from a first location to a second location, comprising:
at least one profile capable of supporting a wheel assembly;
a plurality of wheel assemblies capable of conveying a load, each wheel assembly comprising:
an axle with at least one end capable of mounting to the at least one profile;
at least one wheel rotatably mounted to the axle, the at least one wheel capable of contacting a portion of the load; and
a spring capable of maintaining the position of the respective wheel assembly with the at least one profile, and further capable of permitting the manual removal of the respective wheel assembly from the at least one profile when the spring is compressed against either the at least one wheel or the at least one profile; and
an assembly support capable of mounting the at least one profile to a support structure.

2. The transfer structure of claim 1, wherein the plurality of wheel assemblies is in a spaced apart relation to permit the load to move from one location on the transfer structure to a second location.

3. The transfer structure of claim 1, wherein each wheel assembly further comprises a means capable of spacing apart the at least one wheel and a second wheel rotatably mounted on the axle.

4. The transfer structure of claim 1, wherein the support structure comprises a pallet frame.

5. The transfer structure of claim 1, further comprising:
a lane indexer capable of mounting to a portion of the track assembly support, and further capable of defining at least one path for a load at an input end of the transfer structure.

6. The transfer structure of claim 1, further comprising:
a tray capable of mounting to a portion of the track assembly support, and further capable of receiving a load from an output end of the transfer structure.

7. A method of installing a wheel assembly with respect to a pair of spaced apart profiles associated with an adaptable transfer structure, the adaptable transfer structure capable of mounting to a support structure, comprising:
providing a wheel assembly comprising:
an axle with a first end capable of mounting to a first profile and a second end capable of mounting to a second profile;
at least one wheel rotatably mounted to the axle, the at least one wheel capable of contacting a portion of a load placed on the transfer structure; and
a spring capable of maintaining the position of the wheel assembly with respect to the first profile and the second profile,
mounting the first end of the axle with respect to the first profile;
compressing the spring wherein the second end of the axle can be mounted with respect to the second profile; and
releasing the spring wherein a return force generated by the spring can maintain the position of the wheel assembly with respect to the first profile and the second profile.

8. The method of claim 7, further comprising:
installing a plurality of wheel assemblies with respect to the first profile and second profile.

9. The method of claim 7, further comprising:
compressing the spring wherein the second end of the axle can be removed from mounting with the second profile; and
removing the first end of the axle from mounting with the first profile.

10. A method of conveying a load from first location to a second location using an adaptable transfer structure, comprising:
providing a transfer structure comprising:
a first profile;
a second profile in a spaced apart and parallel relationship with the first profile;
a wheel assembly, comprising:
an axle with a first end capable of mounting to the first profile and a second end capable of mounting to the second profile;
at least one wheel rotatably mounted to the axle, the at least one wheel capable of contacting a portion of a load placed on the transfer structure; and
a spring capable of maintaining the position of the axle and the at least one wheel with respect to the first profile and the second profile, and further capable of permitting the manual removal of the wheel assembly from either the first profile or second profile when the spring is compressed against either the at least one wheel or the at least one profile;
an assembly support capable of mounting the first profile and the second profile to a support structure;
placing a load on an input end of the transfer structure, wherein the at least one wheel is in contact with the load; and
conveying the load across a portion of the transfer structure towards an output end.

11. The method of claim 10, wherein the transfer structure comprises a plurality of wheel assemblies with at least one wheel capable of contacting the load and further capable of conveying the load across a portion of the transfer structure towards an output end.

12. The method of claim 11, wherein the support structure comprises a pallet frame.

13. A wheel assembly for an adaptable transfer structure for conveying a load from one location to a second location, the transfer structure comprising at least a first profile and a second profile in a spaced apart relationship, the wheel assembly comprising:
an axle with a first end capable of mounting to the first profile and a second end capable of mounting to the second profile;
at least one wheel rotatably mounted to the axle, the at least one wheel capable of contacting a portion of a load placed on the transfer structure; and
a spring capable of maintaining the position of the axle and the at least one wheel with respect to the first profile and the second profile, and further capable of permitting the manual removal of the wheel assembly from either the first profile or second profile when the spring is compressed against either the at least one wheel or the at least one profile;
wherein a load placed on an input end of the transfer structure can be conveyed from the input end towards an output end of the adaptable transfer structure.

14. The wheel assembly of claim 13, wherein the at least one wheel comprises at least one of the following: a polycarbonate resin, a composite material, a plastic, a metal.

15. The wheel assembly of claim 13, further comprising a plurality of wheels capable of contacting the load and further capable of conveying the load across a portion of the transfer structure towards an output end.
